(19) United States
(12) Patent Application Publication
(10) Pub. No.: US 2016/0165529 A1
(43) Pub. Date: Jun. 9, 2016

(54) METHOD, APPARATUS, DEVICE, AND SYSTEM FOR CONTROLLING ACCESS TO WIRELESS LOCAL AREA NETWORK

(71) Applicant: HUAWEI TECHNOLOGIES CO., LTD., Shenzhen (CN)

(72) Inventor: Weisheng JIN, Shanghai (CN)

(73) Assignee: HUAWEI TECHNOLOGIES CO., LTD., Shenzhen (CN)

(21) Appl. No.: 15/046,808

(22) Filed: Feb. 18, 2016

Related U.S. Application Data
(63) Continuation of application No. PCT/CN2013/081794, filed on Aug. 19, 2013.

(51) Int. Cl. H04W 48/16; H04W 48/20

(52) U.S. Cl. CPC H04W 48/16; H04W 48/20

(57) ABSTRACT

A method, apparatus, device, and system control access to a wireless local area network, and relate to the field of communications technologies. The method includes: determining, by a first cellular network access node, that a WLAN AP meets an access condition of UE; and sending instruction information to the UE to instruct the UE to access a WLAN network, where the instruction information includes an identifier of the WLAN AP or includes an identifier of the WLAN AP and an identifier of at least one other WLAN AP, and a service provided by the at least one other WLAN AP is the same as a service provided by the WLAN AP.

### CROSS-REFERENCE TO RELATED APPLICATIONS

This application is a continuation of International Application No. PCT/CN2013/081794, filed on Aug. 19, 2013, which is hereby incorporated by reference in its entirety.

### TECHNICAL FIELD

Embodiments of the present invention relate to the field of communications technologies, and in particular, to a method, apparatus, device, and system for controlling access to a wireless local area network.

### BACKGROUND

In recent years, with rapid popularization of an intelligent terminal and a mobile application, the mobile Internet develops rapidly, and therefore, impact of massive data is brought to a mobile network, and an overload case frequently occurs in 2G/3G mobile networks of operators all over the world. Because most of intelligent terminals at present and in the future support a wireless local area network (WLAN), before Long Term Evolution (LTE) is widely deployed, the WLAN mainly used in enterprise and home scenarios originally is universally regarded in the industry as a means that can be used for offloading mobile network data traffic for an operator, and therefore, attracts wide attention. How to improve a network using a WLAN technology to a network form that may be operated by a cellular operator or may interwork with a cellular operator network is a problem that many operators expect to resolve first. Currently, when deploying a small cell, such as a femto cell, a pico cell, or a micro cell, in a cellular network, an operator integrates a WLAN access point (AP) on a base station, which may resolve problems of an arrangement of WLAN APs and sharing of transmission resources of the small cell of the cellular network.

After the WLAN APs are arranged, user equipment (UE) may scan and access a WLAN AP by using an internal WLAN module. However, because passwords are set on some WLAN APs, there are many scenarios in which the UE cannot access, after finding the WLAN APs by means of scanning, the WLAN APs and a service because the UE does not know the passwords. In addition, the UE ceaselessly scans and attempts to access a surrounding WLAN AP, which not only consumes system resources, but also increases power consumption; if the UE automatically accesses a malicious network, a security threat may further be brought. For dual-mode or multi-mode terminals of WLAN and 3rd Generation Partnership Project (3GPP) radio access technology (RATs), to save electricity, ensure security and performance, and the like, WLAN modules of the terminals are generally disabled. Therefore, how to implement that the UE performs effective discovery and selection of a WLAN AP is a problem that needs to be resolved urgently.

At present, in an access network discovery and selection function (ANDSF), information and a policy may be sent to the UE by using a core network server; however, such interaction increases a delay and network load, and has relatively low efficiency. Moreover, the UE may send a query request to a WLAN AP, but the UE cannot determine, before sending the request, whether the WLAN AP can be accessed. Therefore, a large quantity of undirected queries from terminals causes network congestion; and when the UE triggers policy using and execution is implemented by the UE itself, and therefore, a behavior is uncontrollable.

### SUMMARY

Embodiments of the present invention provide a method, apparatus, device, and system for controlling access to a wireless local area network, so as to implement that UE quickly and effectively discovers, selects, and accesses a WLAN AP, and a behavior of the UE is controllable. The technical solutions are as follows:

According to a first aspect, a method for controlling access to a wireless local area network is provided, and the method includes:
determining, by a first cellular network access node, that a wireless local area network access point WLAN AP meets an access condition of user equipment UE; and
sending, by the first cellular network access node, instruction information to the UE to instruct the UE to access a WLAN network, where the instruction information includes an identifier of the WLAN AP or includes an identifier of the WLAN AP and an identifier of at least one other WLAN AP, and a service provided by the at least one other WLAN AP is the same as a service provided by the WLAN AP.

With reference to the first aspect, in a first implementation manner, the method further includes:
acquiring, by the first cellular network access node, a measurement report of a cell of a second cellular network access node from the UE, where
the determining, by a first cellular network access node, that a WLAN AP meets an access condition of user equipment UE includes:
determining, by the first cellular network access node according to transmit power of the second cellular network access node, transmit power of the WLAN AP, and signal quality that is included in the measurement report, that the WLAN AP meets the access condition of the UE, where the signal quality is quality of a signal received by the UE from the second cellular network access node.

With reference to the first implementation manner, in a second implementation manner, the determining, by the first cellular network access node according to transmit power of the second cellular network access node, transmit power of the WLAN AP, and signal quality that is included in the measurement report, that the WLAN AP meets the access condition of the UE, where the signal quality is quality of a signal received by the UE from the second cellular network access node, includes:
determining, by the first cellular network access node according to the transmit power of the second cellular network access node, the transmit power of the WLAN AP, the signal quality that is included in the measurement report, a transmit frequency of the second cellular network access node, and a transmit frequency of the WLAN AP, that the WLAN AP meets the access condition of the UE, where the signal quality is the quality of the signal received by the UE from the second cellular network access node.

With reference to the first or the second implementation manner, in a third implementation manner, the acquiring, by the first cellular network access node, a measurement report of a cell of a second cellular network access node from the UE includes:
sending, by the first cellular network access node, measurement configuration information to the UE, where the measurement configuration information includes a physical cell identifier of the cell of the second cellular network access node; and
receiving the measurement report that is reported by the UE after the UE measures the cell according to the measurement configuration information.

With reference to the first or the second implementation manner, in a fourth implementation manner, the acquiring, by the first cellular network access node, a measurement report of a cell of a second cellular network access node from the UE includes:
sending, by the first cellular network access node, measurement configuration information to the UE, where the measurement configuration information includes measurement instruction information and a physical cell identifier of the cell of the second cellular network access node, and the measurement instruction information is used to instruct the UE to read a cell global identification CGI in a system message of the cell;
receiving the measurement report that is reported by the UE after the UE measures the cell according to the measurement configuration information, where the measurement report includes the CGI; and
determining, according to a fact that the CGI is a CGI of the second cellular network access node, that the measurement report is the measurement report of the cell of the second cellular network access node.

With reference to any one of the first to the fourth implementation manners, in a fifth implementation manner, before the acquiring, by the first cellular network access node, a measurement report of a cell of a second cellular network access node from the UE, the method further includes:
receiving, by the first cellular network access node, a request message sent by the UE, where the request message includes an identifier of the second cellular network access node, and the request message is used to request the first cellular network access node to determine, according to the measurement report of the cell of the second cellular network access node, whether there is a WLAN AP meeting the access condition of the UE.

With reference to the fifth implementation manner, in a sixth implementation manner, the method further includes:
instructing, by the first cellular network access node, the UE to enable a function of sending the request message under a specified condition, where the specified condition is that quality of a signal received by the UE from the second cellular network access node is greater than a specified threshold.

With reference to any one of the first to the sixth implementation manners, in a seventh implementation manner, the method further includes:
receiving, by the first cellular network access node, a notification message that is sent by the UE and that is used to indicate that the UE leaves the second cellular network access node; and
instructing, by the first cellular network access node, the UE to disable a WLAN module.

With reference to any one of the first to the seventh implementation manners, in an eighth implementation manner, the WLAN AP and the second cellular network access node are integrated or co-located.

With reference to the first aspect, in a ninth implementation manner, before the determining, by a first cellular network access node, that a wireless local area network access point WLAN AP meets an access condition of user equipment UE, the method further includes:
receiving, by the first cellular network access node, a request message sent by the UE, where the request message is used to request the first cellular network access node to determine whether there is a WLAN AP meeting the access condition of the UE.

With reference to the ninth implementation manner, in a tenth implementation manner, the method further includes:
instructing, by the first cellular network access node, the UE to enable a function of sending the request message.

With reference to the first aspect or any one of the first to the tenth implementation manners, in an eleventh implementation manner, the instruction information further includes an access manner in which the UE accesses the WLAN AP, and the access manner is determined by the first cellular network access node according to information about the WLAN AP and/or a capability of the UE.

With reference to the eleventh implementation manner, in a twelfth implementation manner, the access manner includes at least one of the following access manners:
an Internet Protocol IP address preservation access manner, an IP address non-preservation access manner, a trusted access manner, an untrusted access manner, an interworking wireless local area network I-WLAN manner, a host-based Mobile Internet Protocol S2c manner, a non-seamless wireless local area network offload NSWO manner, a handover access manner, and a concurrent connection access manner.

With reference to the eleventh or the twelfth implementation manner, in a thirteenth implementation manner, the information about the WLAN AP includes the identifier of the WLAN AP, or the information about the WLAN AP includes the identifier of the WLAN AP and at least one of the following:
a frequency of the WLAN AP;
load of the WLAN AP;
a network access manner supported by the WLAN AP; and
a list of public land mobile networks PLMNs supported by the WLAN AP.

With reference to the first aspect or any one of the first to the thirteenth implementation manners, in a fourteenth implementation manner, before the sending, by the first cellular network access node, instruction information to the UE to instruct the UE to access a WLAN network, the method further includes:
when the WLAN AP is not enabled, sending, by the first cellular network access node, an enable instruction to the WLAN AP to instruct the WLAN AP to enter a running state.

With reference to the first aspect or any one of the first to the fourteenth implementation manners, in a fifteenth implementation manner, the method further includes:
indicating, by the first cellular network access node, a specified frequency and/or transmit power to the WLAN AP.

With reference to the first aspect or any one of the first to the fifteenth implementation manners, in a sixteenth implementation manner, the instruction information further includes at least one of the following:
a frequency of the WLAN AP;
load of the WLAN AP;
a network access manner supported by the WLAN AP or a network access manner indicated to the UE; and
a list of PLMNs supported by the WLAN AP or a list of PLMNs that is indicated to the UE.

With reference to the first aspect or any one of the first to the sixteenth implementation manners, in a seventeenth implementation manner, that a service provided by the at least one other WLAN AP is the same as a service provided by the WLAN AP includes:
a service set identifier SSID corresponding to the at least one other WLAN AP is the same as an SSID corresponding to the WLAN AP.

According to a second aspect, a method for controlling access to a wireless local area network is provided, and the method includes:
receiving, by user equipment UE, instruction information sent by a first cellular network access node, where the instruction information instructs the UE to perform accessing in a WLAN manner, and the instruction information includes an identifier of a WLAN AP or includes an identifier of the WLAN AP and an identifier of at least one other WLAN AP, where a service provided by the at least one other WLAN AP is the same as a service provided by the WLAN AP, and the WLAN AP meets an access condition of the UE; and
accessing, by the UE, a WLAN network according to the instruction information.

With reference to the second aspect, in a first implementation manner, the method further includes:
receiving, by the UE, measurement configuration information sent by the first cellular network access node, where the measurement configuration information includes a physical cell identifier of a cell of a second cellular network access node; and
reporting, by the UE, a measurement report to the first cellular network access node after measuring the cell according to the measurement configuration information.

With reference to the second aspect, in a second implementation manner, the method further includes:
receiving, by the UE, measurement configuration information sent by the first cellular network access node, where the measurement configuration information includes measurement instruction information and a physical cell identifier of a cell of a second cellular network access node, and the measurement instruction information is used to instruct the UE to read a cell global identification CGI in a system message of the cell; and
reporting, by the UE, a measurement report to the first cellular network access node after measuring the cell according to the measurement configuration information, where the measurement report includes the CGI.

With reference to the first or the second implementation manner of the second aspect, in a third implementation manner, before the receiving, by user equipment UE, instruction information sent by a first cellular network access node, the method further includes:
sending, by the UE, a request message to the first cellular network access node, where the request message includes an identifier of the second cellular network access node, and the request message is used to request the first cellular network access node to determine, according to the measurement report of the cell of the second cellular network access node, whether there is a WLAN AP meeting the access condition of the UE.

With reference to the first or the second implementation manner of the second aspect, in a fourth implementation manner, before the receiving, by user equipment UE, instruction information sent by a first cellular network access node, the method further includes:
sending, by the UE, a request message to the first cellular network access node, where the request message includes an identifier of the second cellular network access node and the identifier of the WLAN AP, and the request message is used to request the first cellular network access node to determine, according to the measurement report of the cell of the second cellular network access node, whether the WLAN AP corresponding to the identifier of the WLAN AP meets the access condition of the UE.

With reference to the third implementation manner of the second aspect, in a fifth implementation manner, before the sending, by the UE, a request message to the first cellular network access node, the method further includes:
detecting, by the UE, that quality of a signal received from the second cellular network access node is greater than a first specified threshold.

With reference to the fourth implementation manner of the second aspect, in a sixth implementation manner, before the sending, by the UE, a request message to the first cellular network access node, the method further includes:
detecting, by the UE, that quality of a signal received from the second cellular network access node is greater than a first specified threshold; and
finding, by the UE by means of querying, a correspondence between the second cellular network access node and the WLAN AP from a historical access record.

With reference to the fifth or the sixth implementation manner of the second aspect, in a seventh implementation manner, the method further includes:
receiving, by the UE, an instruction that is sent by the first cellular network access node and that instructs to enable a function of sending the request message under a specified condition, where
the specified condition is that quality of a signal received by the UE from the second cellular network access node is greater than the first specified threshold.

With reference to any one of the third to the seventh implementation manners of the second aspect, in an eighth implementation manner, the method further includes:
detecting, by the UE, that the quality of the signal received from the second cellular network access node is less than a second specified threshold;
sending, by the UE, a leave notification message to the first cellular network access node; and
receiving, by the UE, an instruction message that is sent by the first cellular network access node and that is used to instruct the UE to disable a WLAN module.

With reference to any one of the first to the eighth implementation manners of the second aspect, in a ninth implementation manner, the WLAN AP and the second cellular network access node are integrated or co-located.

With reference to the first implementation manner of the second aspect, in a tenth implementation manner, before the receiving, by user equipment UE, instruction information sent by a first cellular network access node, the method further includes:
sending, by the UE, a request message to the first cellular network access node, where the request message is used to request the first cellular network access node to determine whether there is a WLAN AP meeting the access condition of the UE.

With reference to the tenth implementation manner of the second aspect, in an eleventh implementation manner, the method further includes:
receiving, by the UE, an instruction that is sent by the first cellular network access node and that instructs the UE to enable a function of sending the request message.

With reference to the second aspect or any one of the first to the eleventh implementation manners, in a twelfth implementation manner, the accessing, by the UE, a WLAN network according to the instruction information includes:
enabling, by the UE, a WLAN module;
using, by the UE, the WLAN module to scan a surrounding WLAN AP; and
accessing the WLAN AP that is found by means of scanning and that is indicated in the instruction information, or accessing one WLAN AP, found by means of scanning, of the at least one other WLAN AP and the WLAN AP that are indicated in the instruction information.

With reference to the twelfth implementation manner of the second aspect, in a thirteenth implementation manner, the accessing one WLAN AP, found by means of scanning, of the at least one other WLAN AP and the WLAN AP that are indicated in the instruction information includes:
accessing one WLAN AP, having best signal quality and found by means of scanning, of the at least one other WLAN AP and the WLAN AP that are indicated in the instruction information.

With reference to the second aspect or any one of the first to the thirteenth implementation manners, in a fourteenth implementation manner, the instruction information further includes an access manner in which the UE accesses the WLAN AP.

With reference to the fourteenth implementation manner of the second aspect, in a fifteenth implementation manner, the access manner includes at least one of the following access manners:
an Internet Protocol IP address preservation access manner, an IP address non-preservation access manner, a trusted access manner, an untrusted access manner, an interworking wireless local area network I-WLAN manner, a host-based Mobile Internet Protocol S2c manner, a non-seamless wireless local area network offload NSWO manner, a handover access manner, and a concurrent connection access manner.

With reference to the second aspect or any one of the first to the fifteenth implementation manners, in a sixteenth implementation manner, that a service provided by the at least one other WLAN AP is the same as a service provided by the WLAN AP includes:
a service set identifier SSID corresponding to the at least one other WLAN AP is the same as an SSID corresponding to the WLAN AP.

According to a third aspect, an apparatus for controlling access to a wireless local area network is provided, and the apparatus includes:
a determining module, configured to determine that a wireless local area network access point WLAN AP meets an access condition of user equipment UE; and
a sending module, configured to: after the determining module determines that the WLAN AP meets the access condition of the UE, send instruction information to the UE to instruct the UE to access a WLAN network, where the instruction information includes an identifier of the WLAN AP or includes an identifier of the WLAN AP and an identifier of at least one other WLAN AP, and a service provided by the at least one other WLAN AP is the same as a service provided by the WLAN AP.

With reference to the third aspect, in a first implementation manner, the apparatus further includes:
a receiving module, configured to acquire a measurement report of a cell of a second cellular network access node from the UE, where
the determining module includes:
a determining unit, configured to determine, according to transmit power of the second cellular network access node, transmit power of the WLAN AP, and signal quality that is included in the measurement report, that the WLAN AP meets the access condition of the UE, where the signal quality is quality of a signal received by the UE from the second cellular network access node.

With reference to the first implementation manner of the third aspect, in a second implementation manner, the determining unit is configured to:
determine, according to the transmit power of the second cellular network access node, the transmit power of the WLAN AP, the signal quality that is included in the measurement report, a transmit frequency of the second cellular network access node, and a transmit frequency of the WLAN AP, that the WLAN AP meets the access condition of the UE, where the signal quality is the quality of the signal received by the UE from the second cellular network access node.

With reference to the first or the second implementation manner of the third aspect, in a third implementation manner, the sending module is further configured to:
send measurement configuration information to the UE, where the measurement configuration information includes a physical cell identifier of the cell of the second cellular network access node; and
the receiving module is configured to:
receive the measurement report that is reported by the UE after the UE measures the cell according to the measurement configuration information.

With reference to the first or the second implementation manner of the third aspect, in a fourth implementation manner, the sending module is further configured to:
send measurement configuration information to the UE, where the measurement configuration information includes measurement instruction information and a physical cell identifier of the cell of the second cellular network access node, and the measurement instruction information is used to instruct the UE to read a cell global identification CGI in a system message of the cell;
the receiving module is configured to:
receive the measurement report that is reported by the UE after the UE measures the cell according to the measurement configuration information, where the measurement report includes the CGI; and
the determining module is configured to:
determine, according to a fact that the CGI is a CGI of the second cellular network access node, that the measurement report is the measurement report of the cell of the second cellular network access node.

With reference to any one of the first to the fourth implementation manners of the third aspect, in a fifth implementation manner, the receiving module is further configured to:
before acquiring the measurement report of the cell of the second cellular network access node from the UE, receive a request message sent by the UE, where the request message is used to request the first cellular network access node to determine, according to the measurement report of the cell of the second cellular network access node, whether there is a WLAN AP meeting the access condition of the UE.

With reference to the fifth implementation manner of the third aspect, in a sixth implementation manner, the sending module is further configured to:
instruct the UE to enable a function of sending the request message under a specified condition, where the specified condition is that quality of a signal received by the UE from the second cellular network access node is greater than a specified threshold.

With reference to any one of the first to the sixth implementation manners of the third aspect, in a seventh implementation manner, the receiving module is further configured to:
receive a notification message that is sent by the UE and that is used to indicate that the UE leaves the second cellular network access node; and
the sending module is further configured to:
instruct the UE to disable a WLAN module.

With reference to any one of the first to the seventh implementation manners of the third aspect, in an eighth implementation manner, the WLAN AP and the second cellular network access node are integrated or co-located.

With reference to the third aspect, in a ninth implementation manner, the apparatus further includes:
a receiving module, configured to: before the determining module determines that the wireless local area network access point WLAN AP meets the access condition of the user equipment UE, receive a request message sent by the UE, where the request message is used to request the first cellular network access node to determine whether there is a WLAN AP meeting the access condition of the UE.

With reference to the ninth implementation manner of the third aspect, in a tenth implementation manner, the sending module is further configured to:
instruct the UE to enable a function of sending the request message.

With reference to the third aspect or any one of the first to the tenth implementation manners, in an eleventh implementation manner, the instruction information further includes an access manner in which the UE accesses the WLAN AP, and the access manner is determined by the first cellular network access node according to information about the WLAN AP and/or a capability of the UE.

With reference to the eleventh implementation manner of the third aspect, in a twelfth implementation manner, the access manner includes at least one of the following access manners:
an Internet Protocol IP address preservation access manner, an IP address non-preservation access manner, a trusted access manner, an untrusted access manner, an interworking wireless local area network I-WLAN manner, a host-based Mobile Internet Protocol S2c manner, a non-seamless wireless local area network offload NSWO manner, a handover access manner, and a concurrent connection access manner.

With reference to the eleventh or the twelfth implementation manner of the third aspect, in a thirteenth implementation manner, the information about the WLAN AP includes the identifier of the WLAN AP, or the information about the WLAN AP includes the identifier of the WLAN AP and at least one of the following:
a frequency of the WLAN AP;
load of the WLAN AP;
a network access manner supported by the WLAN AP; and
a list of public land mobile networks PLMNs supported by the WLAN AP.

With reference to the third aspect or any one of the first to the thirteenth implementation manners, in a fourteenth implementation manner, the sending module is further configured to:
before sending the instruction information to the UE to instruct the UE to access the WLAN network, when the WLAN AP is not enabled, send an enable instruction to the WLAN AP to instruct the WLAN AP to enter a running state.

With reference to the third aspect or any one of the first to the fourteenth implementation manners, in a fifteenth implementation manner, the sending module is further configured to:
indicate a specified frequency and/or transmit power to the WLAN AP.

With reference to the third aspect or any one of the first to the fifteenth implementation manners, in a sixteenth implementation manner, the instruction information further includes at least one of the following:
a frequency of the WLAN AP;
load of the WLAN AP;
a network access manner supported by the WLAN AP or a network access manner indicated to the UE; and
a list of PLMNs supported by the WLAN AP or a list of PLMNs that is indicated to the UE.

With reference to the third aspect or any one of the first to the sixteenth implementation manners, in a seventeenth implementation manner, that a service provided by the at least one other WLAN AP is the same as a service provided by the WLAN AP includes:
a service set identifier SSID corresponding to the at least one other WLAN AP is the same as an SSID corresponding to the WLAN AP.

According to a fourth aspect, an embodiment provides an apparatus for controlling access to a wireless local area network is provided, and the apparatus includes:
a receiving module, configured to receive instruction information sent by a first cellular network access node, where the instruction information instructs to perform accessing in a WLAN manner, and the instruction information includes an identifier of a WLAN AP or includes an identifier of the WLAN AP and an identifier of at least one other WLAN AP, where a service provided by the at least one other WLAN AP is the same as a service provided by the WLAN AP, and the WLAN AP meets an access condition of user equipment UE; and
an accessing module, configured to access a WLAN network according to the instruction information received by the receiving module.

With reference to the fourth aspect, in a first implementation manner, the receiving module is further configured to:
receive measurement configuration information sent by the first cellular network access node, where the measurement configuration information includes a physical cell identifier of a cell of a second cellular network access node; and
the apparatus further includes:
a measuring module, configured to measure the cell according to the measurement configuration information; and
a sending module, configured to report a measurement report to the first cellular network access node after the measuring module performs measurement.

With reference to the fourth aspect, in a second implementation manner, the receiving module is further configured to:
receive measurement configuration information sent by the first cellular network access node, where the measurement configuration information includes measurement instruction information and a physical cell identifier of a cell of a second cellular network access node, and the measurement instruction information is used to instruct to read a cell global identification CGI in a system message of the cell; and
the apparatus further includes:
a measuring module, configured to measure the cell according to the measurement configuration information; and
a sending module, configured to report a measurement report to the first cellular network access node after the measuring module performs measurement, where the measurement report includes the CGI.

With reference to the first or the second implementation manner of the fourth aspect, in a third implementation manner, the sending module is further configured to:
before the receiving module receives the instruction information sent by the first cellular network access node, send a request message to the first cellular network access node, where the request message includes an identifier of the second cellular network access node, and the request message is used to request the first cellular network access node to determine, according to the measurement report of the cell of the second cellular network access node, whether there is a WLAN AP meeting the access condition of the UE.

With reference to the first or the second implementation manner of the fourth aspect, in a fourth implementation manner, the sending module is further configured to:
before the receiving module receives the instruction information sent by the first cellular network access node, send a request message to the first cellular network access node, where the request message includes an identifier of the second cellular network access node and the identifier of the WLAN AP, and the request message is used to request the first cellular network access node to determine, according to the measurement report of the cell of the second cellular network access node, whether the WLAN AP corresponding to the identifier of the WLAN AP meets the access condition of the UE.

With reference to the third implementation manner of the fourth aspect, in a fifth implementation manner, the apparatus further includes:
a detecting module, configured to: before the sending module sends the request message to the first cellular network access node, detect that quality of a signal received from the second cellular network access node is greater than a first specified threshold.

With reference to the fourth implementation manner of the fourth aspect, in a sixth implementation manner, the apparatus further includes:
a detecting module, configured to: before the sending module sends the request message to the first cellular network access node, detect that quality of a signal received from the second cellular network access node is greater than a first specified threshold; and
a querying module, configured to: after the detecting module detects that the quality of the signal received from the second cellular network access node is greater than the first specified threshold, find, by means of querying, a correspondence between the second cellular network access node and the WLAN AP from a historical access record.

With reference to the fifth or the sixth implementation manner of the fourth aspect, in a seventh implementation manner, the receiving module is further configured to:
receive an instruction that is sent by the first cellular network access node and that instructs to enable a function of sending the request message under a specified condition, where
the specified condition is that quality of a signal received by the UE from the second cellular network access node is greater than the first specified threshold.

With reference to any one of the third to the seventh implementation manners of the fourth aspect, in an eighth implementation manner, the apparatus further includes:
a leave detecting module, configured to detect that the quality of the signal received from the second cellular network access node is less than a second specified threshold, where
the sending module is further configured to send a leave notification message to the first cellular network access node; and
the receiving module is further configured to receive an instruction message that is sent by the first cellular network access node and that is used to instruct the UE to disable a WLAN module.

With reference to any one of the first to the eighth implementation manners of the fourth aspect, in a ninth implementation manner, the WLAN AP and the second cellular network access node are integrated or co-located.

With reference to the first implementation manner of the fourth aspect, in a tenth implementation manner, the sending module is further configured to:
before the receiving module receives the instruction information sent by the first cellular network access node, send a request message to the first cellular network access node, where the request message is used to request the first cellular network access node to determine whether there is a WLAN AP meeting the access condition of the UE.

With reference to the tenth aspect, in an eleventh implementation manner, the receiving module is further configured to:
receive an instruction that is sent by the first cellular network access node and that instructs the UE to enable a function of sending the request message.

With reference to the fourth aspect or any one of the first to the eleventh implementation manners, in a twelfth implementation manner, the accessing module includes:
an enabling unit, configured to enable a WLAN module;
a scanning unit, configured to use the WLAN module to scan a surrounding WLAN AP; and
an access unit, configured to: access the WLAN AP that is found by means of scanning and that is indicated in the instruction information, or access one WLAN AP, found by means of scanning, of the at least one other WLAN AP and the WLAN AP that are indicated in the instruction information.

With reference to the twelfth implementation manner of the fourth aspect, in a thirteenth implementation manner, the access unit is configured to:
access one WLAN AP, having best signal quality and found by means of scanning, of the at least one other WLAN AP and the WLAN AP that are indicated in the instruction information.

With reference to the fourth aspect or any one of the first to the thirteenth implementation manners, in a fourteenth implementation manner, the instruction information further includes an access manner of accessing the WLAN AP.

With reference to the fourteenth implementation manner of the fourth aspect, in a fifteenth implementation manner, the access manner includes at least one of the following access manners:
an Internet Protocol IP address preservation access manner, an IP address non-preservation access manner, a trusted access manner, an untrusted access manner, an interworking wireless local area network I-WLAN manner, a host-based Mobile Internet Protocol S2c manner, a non-seamless wireless local area network offload NSWO manner, a handover access manner, and a concurrent connection access manner.

With reference to the fourth aspect or any one of the first to the fifteenth implementation manners, in a sixteenth implementation manner, that a service provided by the at least one other WLAN AP is the same as a service provided by the WLAN AP includes:
a service set identifier SSID corresponding to the at least one other WLAN AP is the same as an SSID corresponding to the WLAN AP.

According to a fifth aspect, a cellular network access node is provided, including:
the apparatus for controlling access to a wireless local area network according to the third aspect or any one of the first to the seventeenth implementation manners of the third aspect.

According to a sixth aspect, user equipment UE is provided, including: the apparatus for controlling access to a wireless local area network according to the fourth aspect or any one of the first to the sixteenth implementation manners of the fourth aspect.

According to a seventh aspect, a system for controlling access to a wireless local area network is provided, including: the cellular network access node according to the fifth aspect and the user equipment according to the sixth aspect.

According to the technical solutions provided in the embodiments of the present invention, a first cellular network access node determines that a wireless local area network access point WLAN AP meets an access condition of user equipment UE, and sends instruction information to the UE to instruct the UE to access a WLAN network, where the instruction information includes an identifier of the WLAN AP or includes an identifier of the WLAN AP and an identifier of at least one other WLAN AP, and a service provided by the at least one other WLAN AP is the same as a service provided by the WLAN AP; therefore, the UE can be directed to discover, select, and access a WLAN, so as to implement that a behavior of the UE is controllable, electricity of the UE is saved, and power consumption of the UE is reduced.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic diagram of a network architecture according to an embodiment of the present invention;

FIG. 2 is a flowchart of a method for controlling access to a wireless local area network according to Embodiment 1 of the present invention;

FIG. 3 is a flowchart of a method for controlling access to a wireless local area network according to Embodiment 2 of the present invention;

FIG. 4 is a flowchart of another method for controlling access to a wireless local area network according to Embodiment 2 of the present invention;

FIG. 5 is a flowchart of still another method for controlling access to a wireless local area network according to Embodiment 2 of the present invention;

FIG. 6 is a flowchart of a method for controlling access to a wireless local area network according to Embodiment 3 of the present invention;

FIG. 7 is a flowchart of a method for controlling access to a wireless local area network according to Embodiment 4 of the present invention;

FIG. 8 is a flowchart of another method for controlling access to a wireless local area network according to Embodiment 4 of the present invention;

FIG. 9 is a flowchart of still another method for controlling access to a wireless local area network according to Embodiment 4 of the present invention;

FIG. 10 is a schematic diagram of a scenario of multiple WLAN APs according to Embodiment 4 of the present invention;

FIG. 11 is a flowchart of a method for controlling access to a wireless local area network according to Embodiment 5 of the present invention;

FIG. 12 is a schematic diagram of a network architecture according to Embodiment 6 of the present invention;

FIG. 13 is a flowchart of a method for controlling access to a wireless local area network according to Embodiment 6 of the present invention;

FIG. 14 is a flowchart of a method for controlling access to a wireless local area network according to Embodiment 7 of the present invention;

FIG. 15 is a structural diagram of an apparatus for controlling access to a wireless local area network according to Embodiment 9 of the present invention;

FIG. 16 is a structural diagram of another apparatus for controlling access to a wireless local area network according to Embodiment 9 of the present invention;

FIG. 17 is a structural diagram of still another apparatus for controlling access to a wireless local area network according to Embodiment 9 of the present invention;

FIG. 18 is a structural diagram of an apparatus for controlling access to a wireless local area network according to Embodiment 10 of the present invention;

FIG. 19 is a structural diagram of another apparatus for controlling access to a wireless local area network according to Embodiment 10 of the present invention;

FIG. 20 is a structural diagram of still another apparatus for controlling access to a wireless local area network according to Embodiment 10 of the present invention;

FIG. 21 is a structural diagram of an apparatus for controlling access to a wireless local area network according to Embodiment 11 of the present invention;

FIG. 22 is a structural diagram of an apparatus for controlling access to a wireless local area network according to Embodiment 11 of the present invention;

FIG. 23 is a structural diagram of an apparatus for controlling access to a wireless local area network according to Embodiment 12 of the present invention;

FIG. 24 is a structural diagram of an apparatus for controlling access to a wireless local area network according to Embodiment 12 of the present invention; and

FIG. 25 is a structural diagram of a system for controlling access to a wireless local area network according to Embodiment 13 of the present invention.

### DESCRIPTION OF EMBODIMENTS

To make the objectives, technical solutions, and advantages of the present invention clearer, the following further describes the embodiments of the present invention in detail with reference to the accompanying drawings.

The embodiments of the present invention relate to access to a WLAN, where a WLAN AP is deployed on a cellular network access node, and the deployment may be performed in an integrated or co-located manner. The cellular network access node in the embodiments of the present invention may be an independent device, or may include multiple devices.

For example, the cellular network access node may be an evolved node base (eNodeB) in LTE, or the cellular network access node includes a radio network controller (RNC) and a node base (NodeB) that are in 3G, or the cellular network access node includes a base station controller (BSC) and a base transceiver station (BTS) that are in 2G.

A first cellular network access node involved in the embodiments of the present invention refers to a cellular network access node on which UE currently camps, and the cellular network access node currently provides a service for the UE; a involved second cellular network access node refers to a cellular network access node with which a WLAN AP is integrated or co-located. The second cellular network access node may be a small cell, for example, a femto cell, a pico cell, a micro cell, an radio remote unit (RRU), or the like, in a cellular network such as 2G, 3G, LTE, Code Division Multiple Access (CDMA) 2000, or the like.

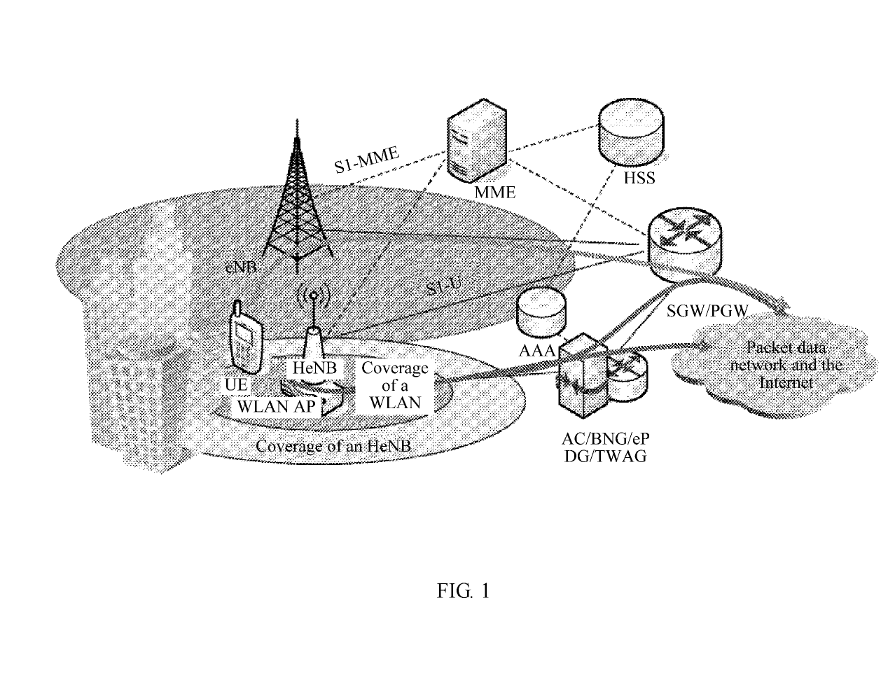

Referring to FIG. 1, FIG. 1 is a schematic diagram of a network architecture according to an embodiment of the present invention, where LTE is used as an example for description. An eNB is a first cellular network access node, and an Home evolved NodeB or Home NodeB (HeNB) is a second cellular network access node, with which a WLAN AP is integrated or co-located. UE currently camps in coverage of the eNB, and the UE is also in coverage of the WLAN AP and the HeNB; therefore, the eNB may control the UE to access the WLAN AP, so that the UE quickly and effectively discovers, selects, and accesses the WLAN AP. It should be noted that a small cell (small cell) used as the second cellular network access node may be a home (evolved) NodeB (femto cell) shown in the figure, or may be a pico cell, a micro cell, or the like.

### Embodiment 1

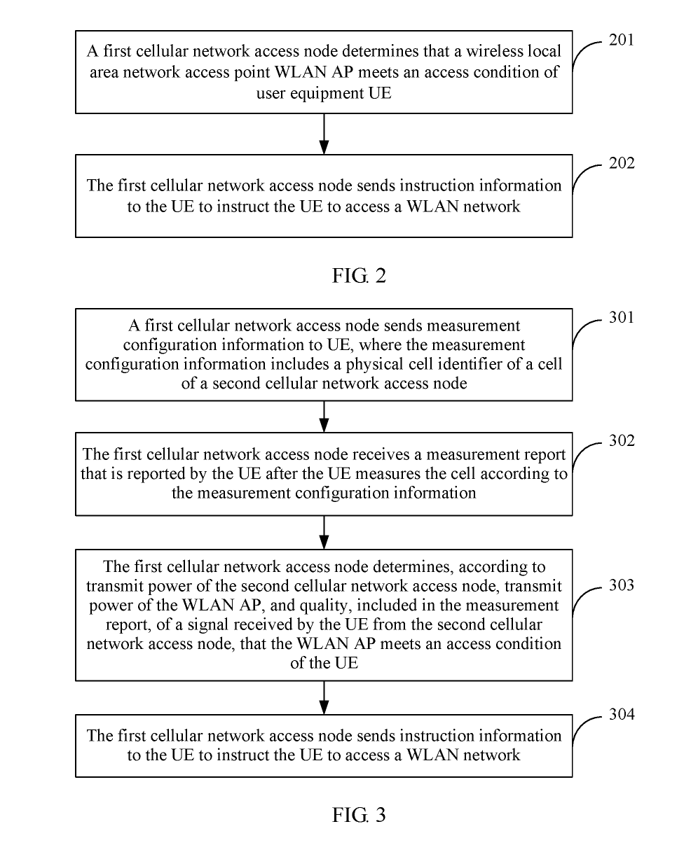

Referring to FIG. 2, this embodiment provides a method for controlling access to a wireless local area network, and the method includes the following steps:

201. A first cellular network access node determines that a wireless local area network access point WLAN AP meets an access condition of user equipment UE.

202. The first cellular network access node sends instruction information to the UE to instruct the UE to access a WLAN network, where the instruction information includes an identifier of the WLAN AP or includes an identifier of the WLAN AP and an identifier of at least one other WLAN AP, and a service provided by the at least one other WLAN AP is the same as a service provided by the WLAN AP.

In this embodiment, that a service provided by the at least one other WLAN AP is the same as a service provided by the WLAN AP may be specifically that an service set identifier (SSID) corresponding to the at least one other WLAN AP is the same as an SSID corresponding to the WLAN AP.

In this embodiment, the method may further include:
acquiring, by the first cellular network access node, a measurement report of a cell of a second cellular network access node from the UE.

The determining, by a first cellular network access node, that a WLAN AP meets an access condition of user equipment UE includes:
determining, by the first cellular network access node according to transmit power of the second cellular network access node, transmit power of the WLAN AP, and signal quality that is included in the measurement report, that the WLAN AP meets the access condition of the UE, where the signal quality is quality of a signal received by the UE from the second cellular network access node.

The measurement report includes at least an identifier of the second cellular network access node and quality information of the signal received by the UE from the second cellular network access node. The quality information of the signal includes but is not limited to: received signal strength, received signal power, or the like. This embodiment sets no specific limitation thereto.

In this embodiment, further, the determining, by the first cellular network access node according to transmit power of the second cellular network access node, transmit power of the WLAN AP, and quality, included in the measurement report, of a signal received by the UE from the second cellular network access node, that the WLAN AP meets the access condition of the UE may include:
determining, by the first cellular network access node according to the transmit power of the second cellular network access node, the transmit power of the WLAN AP, the quality, included in the measurement report, of the signal received by the UE from the second cellular network access node, a transmit frequency of the second cellular network access node, and a transmit frequency of the WLAN AP, that the WLAN AP meets the access condition of the UE.

For example, the transmit power of the second cellular network access node is Pc dBm, power of the signal received by the UE from the second cellular network access node is Rc dBm (received signal power is used as an example, and there is a specific conversion relationship between the received signal strength and the received signal power), a loss of a downlink path from the cellular network access node to the UE is PLc, and the transmit frequency of the cellular network access node is fc; the transmit power of the WLAN AP is Pw dBm, power of a signal received by the UE from the WLAN AP is Rw dBm, a loss of a downlink path from the WLAN AP to the UE is PLw, and a frequency of the WLAN AP is fw. Rw may be obtained, by means of calculation, by using the following method:

PLc=Pc−Rc;

PLw=Pw−Rw;

PLw=PLc−20 log₁₀(fc/fw);

Rw=Pw−[Pc−Rc−20 log₁₀(fc/fw)].

The first cellular network access node that receives the measurement report may determine, according to Rw obtained by means of calculation, whether possible power of a signal currently received by the UE from the WLAN AP can reach a preset threshold; if the threshold is reached, it is considered that in a current position, the UE is suitable to access the WLAN AP, that is, the WLAN AP can meet the access condition of the UE; if the threshold is not reached, it is considered that in the current position, the UE is unsuitable to access the WLAN AP, that is, the WLAN AP cannot meet the access condition of the UE.

In this embodiment, further, the acquiring, by the first cellular network access node, a measurement report of a cell of a second cellular network access node from the UE may include:
sending, by the first cellular network access node, measurement configuration information to the UE, where the measurement configuration information includes a physical cell identifier of the cell of the second cellular network access node; and
receiving the measurement report that is reported by the UE after the UE measures the cell according to the measurement configuration information.

In this embodiment, further, the acquiring, by the first cellular network access node, a measurement report of a cell of a second cellular network access node from the UE may include:
sending, by the first cellular network access node, measurement configuration information to the UE, where the measurement configuration information includes measurement instruction information and a physical cell identifier of the cell of the second cellular network access node, and the measurement instruction information is used to instruct the UE to read a cell global identification CGI in a system message of the cell;
receiving the measurement report that is reported by the UE after the UE measures the cell according to the measurement configuration information, where the measurement report includes the CGI; and
determining, according to a fact that the CGI is a CGI of the second cellular network access node, that the measurement report is the measurement report of the cell of the second cellular network access node.

That the measurement instruction information instructs the UE to read the CGI in the system message of the cell is mainly considered from two aspects. First, after the UE measures the second cellular network access node, physical cell identifiers in the measurement report may be in conflict, physical cell identifiers of different cellular network access nodes may be duplicate, and a network needs to determine, according to the CGI, a target cellular network access node to which the measurement report reported by the UE corresponds. Second, not every site on which a cellular network access node is located is necessarily integrated or co-located with a WLAN AP, and the network needs to find a corresponding record of the cellular network access node according to the CGI and query whether the cellular network access node is integrated or co-located with a WLAN AP.

A reason why the physical cell identifiers are in conflict is that the physical cell identifier is a 9-bit identifier and has a limited selection range. When being used, especially for a cellular network access node with which a WLAN AP is integrated or co-located, in a specific area, for example, within cell coverage of a source base station, the physical cell identifier may be repeatedly used. Generally, the UE needs to report, in a measurement report, only a physical cell identifier and received signal quality, and in this way, it is difficult for the source base station to determine a cell to which the measurement report corresponds; therefore, a conflict between physical cell identifiers occurs.

According to the foregoing method provided in this embodiment, a first cellular network access node determines that a wireless local area network access point WLAN AP meets an access condition of user equipment UE, and sends instruction information to the UE to instruct the UE to access a WLAN network, where the instruction information includes an identifier of the WLAN AP or includes an identifier of the WLAN AP and an identifier of at least one other WLAN AP, and a service provided by the at least one other WLAN AP is the same as a service provided by the WLAN AP, so that the UE can be directed to quickly and effectively discover, select, and access the WLAN. A network determines, according to cellular and WLAN network information learnt by the network and measurement performed by the UE under control, that the UE enters coverage of the WLAN network, which avoids problems that electricity of the UE is consumed excessively fast, an available WLAN network cannot be effectively discovered, and congestion of an air interface of a WLAN network occurs that are caused when the UE continually scans and queries a WLAN network for a long time in a manner of autonomous discovery, and the like; in addition, a behavior of the UE is directed by a cellular network to which the UE currently attaches, and the UE only needs to perform network discovery according to an instruction, so that the behavior is controllable, high efficiency is achieved, and implementation of the UE is simple.

### Embodiment 2

Referring to FIG. 3, this embodiment provides a method for controlling access to a wireless local area network, and the method includes the following steps:

301. A first cellular network access node sends measurement configuration information to UE, where the measurement configuration information includes a physical cell identifier of a cell of a second cellular network access node.

The second cellular network access node is integrated or co-located with a WLAN AP.

302. The first cellular network access node receives a measurement report that is reported by the UE after the UE measures the cell according to the measurement configuration information.

303. The first cellular network access node determines, according to transmit power of the second cellular network access node, transmit power of a WLAN AP, and quality, included in the measurement report, of a signal received by the UE from the second cellular network access node, that the WLAN AP meets an access condition of the UE.

The transmit power of the second cellular network access node and the transmit power of the WLAN AP may be stored on the first cellular network access node, so that it is more convenient to perform a search locally; or may be stored on an SRC (Single Radio Controller, single radio control), and the first cellular network access node may acquire the transmit power of the second cellular network access node and the transmit power of the WLAN AP from the SRC.

304. The first cellular network access node sends instruction information to the UE to instruct the UE to access a WLAN network.

The instruction information includes an identifier of the WLAN AP or includes an identifier of the WLAN AP and an identifier of at least one other WLAN AP, and a service provided by the at least one other WLAN AP is the same as a service provided by the WLAN AP.

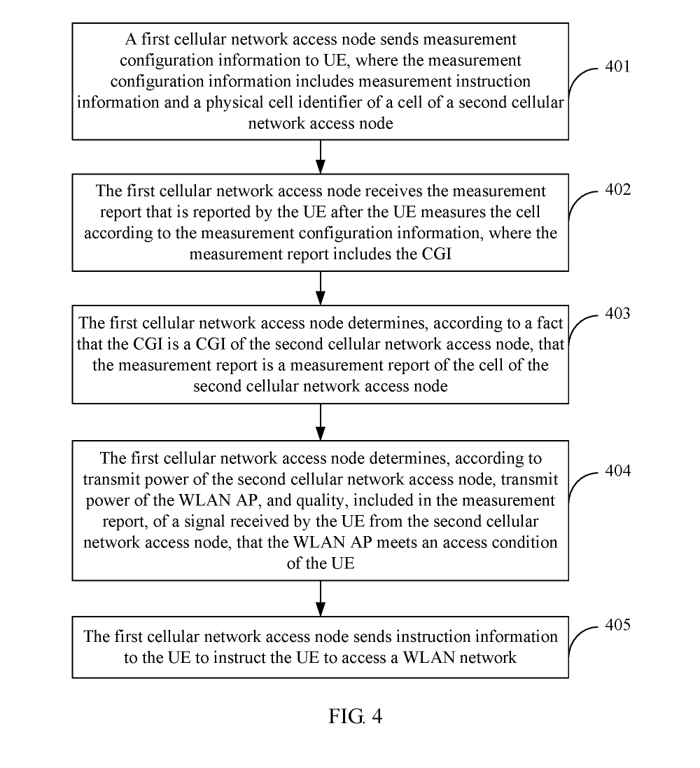

Referring to FIG. 4, this embodiment further provides a method for controlling access to a wireless local area network, and the method includes the following steps:

401. A first cellular network access node sends measurement configuration information to UE, where the measurement configuration information includes measurement instruction information and a physical cell identifier of a cell of a second cellular network access node.

The measurement instruction information is used to instruct the UE to read a cell global identification CGI in a system message of the cell. The second cellular network access node is integrated or co-located with a WLAN AP.

402. The first cellular network access node receives a measurement report that is reported by the UE after the UE measures the cell according to the measurement configuration information, where the measurement report includes a CGI.

403. The first cellular network access node determines, according to a fact that the CGI is a CGI of the second cellular network access node, that the measurement report is a measurement report of the cell of the second cellular network access node.

404. The first cellular network access node determines, according to transmit power of the second cellular network access node, transmit power of the WLAN AP, and quality, included in the measurement report, of a signal received by the UE from the second cellular network access node, that the WLAN AP meets an access condition of the UE.

405. The first cellular network access node sends instruction information to the UE to instruct the UE to access a WLAN network.

The instruction information includes an identifier of the WLAN AP or includes an identifier of the WLAN AP and an identifier of at least one other WLAN AP, and a service provided by the at least one other WLAN AP is the same as a service provided by the WLAN AP.

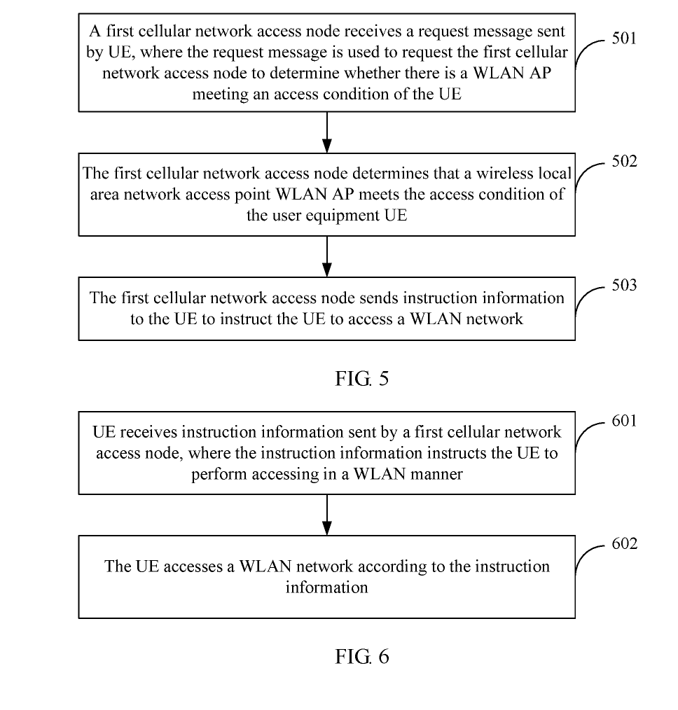

Referring to FIG. 5, this embodiment further provides a method for controlling access to a wireless local area network, and the method includes the following steps:

501. A first cellular network access node receives a request message sent by UE, where the request message is used to request the first cellular network access node to determine whether there is a WLAN AP meeting an access condition of the UE.

Further, the first cellular network access node may further instruct the UE to enable a function of sending the request message.

502. The first cellular network access node determines that a wireless local area network access point WLAN AP meets the access condition of the user equipment UE.

503. The first cellular network access node sends instruction information to the UE to instruct the UE to access a WLAN network.

The instruction information includes an identifier of the WLAN AP or includes an identifier of the WLAN AP and an identifier of at least one other WLAN AP, and a service provided by the at least one other WLAN AP is the same as a service provided by the WLAN AP.

In addition, the request message may further include an identifier of a second cellular network access node; accordingly, the request message is used to request the first cellular network access node to determine, according to a measurement report of a cell of the second cellular network access node, whether there is a WLAN AP meeting the access condition of the UE.

If the request message includes the identifier of the second cellular network access node, the method may further include:
instructing, by the first cellular network access node, the UE to enable a function of sending the request message under a specified condition, where the specified condition is that quality of a signal received by the UE from the second cellular network access node is greater than a specified threshold.

Further, the method may further include:
receiving, by the first cellular network access node, a notification message that is sent by the UE and that is used to indicate that the UE leaves the second cellular network access node, and instructing the UE to disable a WLAN module.

In any one of the foregoing methods provided in this embodiment, the determining, by the first cellular network access node according to transmit power of the second cellular network access node, transmit power of the WLAN AP, and quality, included in the measurement report, of a signal received by the UE from the second cellular network access node, that the WLAN AP meets an access condition of the UE may include:
determining, by the first cellular network access node according to the transmit power of the second cellular network access node, the transmit power of the WLAN AP, the signal quality that is included in the measurement report, a transmit frequency of the second cellular network access node, and a transmit frequency of the WLAN AP, that the WLAN AP meets the access condition of the UE, where the signal quality is the quality of the signal received by the UE from the second cellular network access node.

In any one of the foregoing methods provided in this embodiment, the instruction information further includes an access manner in which the UE accesses the WLAN AP, and the access manner is determined by the first cellular network access node according to information about the WLAN AP and/or a capability of the UE.

The access manner includes at least one of the following access manners:
an Internet Protocol IP address preservation access manner, an IP address non-preservation access manner, a trusted access manner, an untrusted access manner, an interworking wireless local area network I-WLAN manner, a host-based Mobile Internet Protocol S2c manner, a non-seamless wireless local area network offload NSWO manner, a handover access manner, and a concurrent connection access manner.

In this embodiment, UE with different capabilities can access the WLAN AP in different manners, and if an operator network supports only one or several access manners, UE with no capability of this/these access manners cannot access the WLAN AP. In this embodiment, the handover access manner means that the UE transfers all data flows to the WLAN AP to perform transmission, and the concurrent connection access manner means that the UE transfers some data flows to the WLAN AP to perform transmission. When the access manner in which the UE accesses the WLAN AP is indicated to the UE, before accessing the WLAN AP, the UE may conveniently determine, according to the capability of the UE and the instruction, whether the WLAN AP is suitable for being accessed. Alternatively, the access manner in which the UE accesses the WLAN AP may also be configured on the UE by a user.

The information about the WLAN AP includes the identifier of the WLAN AP, or the information about the WLAN AP includes the identifier of the WLAN AP and at least one of the following:
a frequency of the WLAN AP;
load of the WLAN AP;
a network access manner supported by the WLAN AP; and
a list of PLMNs supported by the WLAN AP.

The load of the WLAN AP refers to a comprehensive load capability of the WLAN AP, and may be represented by a percentage of resources already used by the WLAN AP in total resources or a percentage of resources that are not used by the WLAN AP in total resources. The resources include but are not limited to an air interface resource, backhaul bandwidth, a processing resource, a connection capacity, and the like that are of the WLAN AP.

The list of PLMNs includes an identifier of at least one PLMN, and a PLMN supported by the WLAN AP may be learned according to the identifier.

The capability of the UE includes but is not limited to one or more of the following: whether a concurrent offloading service (for example, IFOM, MAPCON, and NSWO) is supported, a supported network access manner, a cellular radio access technology (LTE, UMTS, and GPRS) capability of the UE, and a WLAN capability (a supported 802.11 technical version and a frequency) of the UE.

In this embodiment, the WLAN may further provide an non-seamless WLAN offload (NSWO) service or a concurrent offloading service to the UE. The NSWO means that the UE accesses a cellular network and receives/sends data through an air interface of the WLAN at the same time. The UE accesses a core network gateway in the cellular network, establishes a packet data network (PDN) connection, and uses an IP address assigned by the core network gateway to communicate with a peer end; in the WLAN, the UE directly accesses a service network through a fixed network, and uses an IP address assigned by the fixed network to communicate with a peer end.

The concurrent offloading service includes a seamless concurrent offloading IP flow mobility (IFOM) service or a non-seamless concurrent offloading multi access PDN connectivity (MAPCON) service. The IFOM means that the UE accesses a cellular network and receives/sends data through an air interface of the WLAN at the same time. The UE accesses a same core network gateway separately from the cellular network and the WLAN, and uses a same access point name (APN) to establish two PDN connections. The UE uses, in the cellular and the WLAN, a same IP address assigned by a network (the same core network gateway) to communicate with a peer end. The MAPCON means that the UE accesses a cellular network and receives/sends data through an air interface of the WLAN at the same time. The UE accesses different core network gateways separately from the cellular network and the WLAN, and uses different APNs to establish two PDN connections. The UE uses, in the cellular and the WLAN, different IP addresses assigned by networks (the core network gateways) to communicate with a peer end.

In any one of the foregoing methods provided in this embodiment, the method may further include:
when the WLAN AP is not enabled, sending, by the first cellular network access node, an enable instruction to the WLAN AP to instruct the WLAN AP to enter a running state.

Further, the first cellular network access node may further indicate a specified frequency and/or transmit power to the WLAN AP.

In this scenario, the WLAN AP may adjust a frequency and/or transmit power of the WLAN AP to the specified frequency and/or transmit power.

In this embodiment, preferably, the instruction information sent by the first cellular network access node to the UE may further include at least one of the following:
a frequency of the WLAN AP;
load of the WLAN AP;
a network access manner supported by the WLAN AP or a network access manner indicated to the UE; and
a list of PLMNs supported by the WLAN AP or a list of PLMNs that is indicated to the UE.

In any implementation manner of this embodiment, the identifier of the WLAN AP includes but is not limited to any one of the following: an SSID (Service Set Identification, service set identifier), a BSSID (Basic Service Set Identification, basic service set identifier), an HESSID (Homogenous Extended Service Set Identifier, homogenous extended service set identifier), an OUI (Organization Universal Identity, organization universal identity), and an OI (Organization Identity, organization identity). The BSSID is a MAC (Media Access Control, Media Access Control) address of an AP, and is a universal unique identifier of the AP. The SSID is a service set identifier of a WLAN of an operator and identifies the WLAN network of the operator. The OUI/OI is a unique identifier of the WLAN roaming organization, and the UE may determine, by using the OUI/OI, whether the UE can access a home network of the UE by means of WLAN AP roaming, where the home network refers to a network that provides WLAN subscription.

In this embodiment, the instruction information may be sent to the UE by using a radio resource control RRC connection message or a user plane message.

In any one of the foregoing methods provided in this embodiment, that a service provided by the at least one other WLAN AP is the same as a service provided by the WLAN AP may include:
a service set identifier SSID corresponding to the at least one other WLAN AP is the same as an SSID corresponding to the WLAN AP.

According to the foregoing methods provided in this embodiment, a first cellular network access node determines that a wireless local area network access point WLAN AP meets an access condition of user equipment UE, and sends instruction information to the UE to instruct the UE to access a WLAN network, where the instruction information includes an identifier of the WLAN AP or includes an identifier of the WLAN AP and an identifier of at least one other WLAN AP, and a service provided by the at least one other WLAN AP is the same as a service provided by the WLAN AP, so that the UE can be directed to quickly and effectively discover, select, and access the WLAN. A network determines, according to cellular and WLAN network information learnt by the network and measurement performed by the UE under control, that the UE enters a WLAN network coverage area, which avoids problems that electricity of the UE is consumed excessively fast, an available WLAN network cannot be effectively discovered, and congestion of an air interface of a WLAN network occurs that are caused when the UE continually scans and queries a WLAN network for a long time in a manner of autonomous discovery, and the like; in addition, a behavior of the UE is directed by a cellular network to which the UE currently attaches, and the UE only needs to perform network discovery according to an instruction, so that the behavior is controllable, high efficiency is achieved, and implementation of the UE is simple.

### Embodiment 3

Referring to FIG. 6, this embodiment provides a method for controlling access to a wireless local area network, and the method includes the following steps:

601. User equipment UE receives instruction information sent by a first cellular network access node, where the instruction information instructs the UE to perform accessing in a WLAN manner, and the instruction information includes an identifier of a WLAN AP or includes an identifier of the WLAN AP and an identifier of at least one other WLAN AP, where a service provided by the at least one other WLAN AP is the same as a service provided by the WLAN AP.

The WLAN AP meets an access condition of the UE.

602. The UE accesses a WLAN network according to the instruction information.

In this embodiment, further, the foregoing method may further include:
receiving, by the UE, measurement configuration information sent by the first cellular network access node, where the measurement configuration information includes a physical cell identifier of a cell of a second cellular network access node; and
reporting, by the UE, a measurement report to the first cellular network access node after measuring the cell according to the measurement configuration information.

Alternatively, the foregoing method may further include:
receiving, by the UE, measurement configuration information sent by the first cellular network access node, where the measurement configuration information includes measurement instruction information and a physical cell identifier of a cell of a second cellular network access node, and the measurement instruction information is used to instruct the UE to read a cell global identification CGI in a system message of the cell; and
reporting, by the UE, a measurement report to the first cellular network access node after measuring the cell according to the measurement configuration information, where the measurement report includes the CGI.

In this embodiment, the accessing, by the UE, a WLAN network according to the instruction information may include:
enabling, by the UE, a WLAN module;
using, by the UE, the WLAN module to scan a surrounding WLAN AP; and
accessing the WLAN AP that is found by means of scanning and that is indicated in the instruction information, or accessing one WLAN AP, found by means of scanning, of the at least one other WLAN AP and the WLAN AP that are indicated in the instruction information.

In the foregoing scenario, the accessing one WLAN AP, found by means of scanning, of the at least one other WLAN AP and the WLAN AP that are indicated in the instruction information includes:
accessing one WLAN AP, having best signal quality and found by means of scanning, of the at least one other WLAN AP and the WLAN AP that are indicated in the instruction information.

Signal quality includes but is not limited to received signal strength or received signal power. The best signal quality refers to strongest received signal strength or largest received signal power, and worst signal quality refers to weakest received signal strength or smallest received signal power.

According to the foregoing method provided in this embodiment, user equipment UE receives instruction information sent by a first cellular network access node, where the instruction information instructs the UE to perform accessing in a WLAN manner, and the instruction information includes an identifier of a WLAN AP or includes an identifier of the WLAN AP and an identifier of at least one other WLAN AP, where a service provided by the at least one other WLAN AP is the same as a service provided by the WLAN AP; and the UE accesses a WLAN network according to the instruction information. In this way, it is implemented that the WLAN AP can be quickly and effectively discovered by the UE, and a success rate of accessing a WLAN of a cellular network operator by the UE and utilization of the WLAN network are effectively improved, so that the WLAN network of the cellular network operator can effectively offload data flow pressure for a cellular network, thereby improving a throughput of an entire network. In addition, accessing is performed according to the received instruction, which avoids problems that electricity of the UE is consumed excessively fast, an available WLAN network cannot be effectively discovered, and congestion of an air interface of a WLAN network occurs that are caused when the UE continually scans and queries a WLAN network for a long time in a manner of autonomous discovery, and the like; in addition, a behavior of the UE is directed by a first cellular network to which the UE currently attaches, and the UE only needs to perform network discovery according to an instruction, so that the behavior is controllable, high efficiency is achieved, and implementation of the UE is simple.

### Embodiment 4

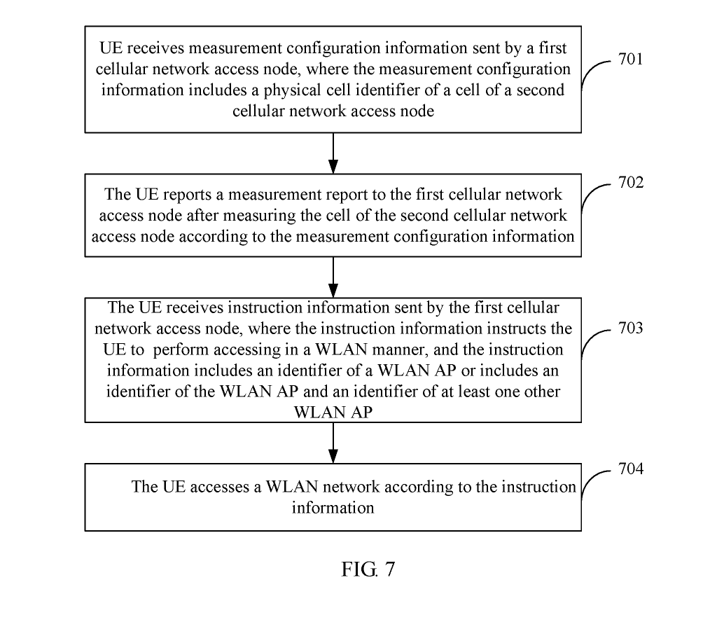

Referring to FIG. 7, this embodiment provides a method for controlling access to a wireless local area network, and the method includes the following steps:

701. UE receives measurement configuration information sent by a first cellular network access node, where the measurement configuration information includes a physical cell identifier of a cell of a second cellular network access node.

The second cellular network access node is integrated or co-located with a WLAN AP.

702. The UE reports a measurement report to the first cellular network access node after measuring the cell of the second cellular network access node according to the measurement configuration information.

703. The UE receives instruction information sent by the first cellular network access node, where the instruction information instructs the UE to perform accessing in a WLAN manner, and the instruction information includes an identifier of a WLAN AP or includes an identifier of the WLAN AP and an identifier of at least one other WLAN AP, where a service provided by the at least one other WLAN AP is the same as a service provided by the WLAN AP, and the WLAN AP meets an access condition of the UE.

704. The UE accesses a WLAN network according to the instruction information.

Referring to FIG. 8, this embodiment further provides a method for controlling access to a wireless local area network, and the method includes the following steps:

801. UE receives measurement configuration information sent by a first cellular network access node, where the measurement configuration information includes measurement instruction information and a physical cell identifier of a cell of a second cellular network access node, and the measurement instruction information is used to instruct the UE to read a cell global identification CGI in a system message of the cell.

The second cellular network access node is integrated or co-located with a WLAN AP.

802. The UE reports a measurement report to the first cellular network access node after measuring the cell according to the measurement configuration information, where the measurement report includes the CGI.

803. The UE receives instruction information sent by the first cellular network access node, where the instruction information instructs the UE to perform accessing in a WLAN manner, and the instruction information includes an identifier of a WLAN AP or includes an identifier of the WLAN AP and an identifier of at least one other WLAN AP, where a service provided by the at least one other WLAN AP is the same as a service provided by the WLAN AP, and the WLAN AP meets an access condition of the UE.

804. The UE accesses a WLAN network according to the instruction information.

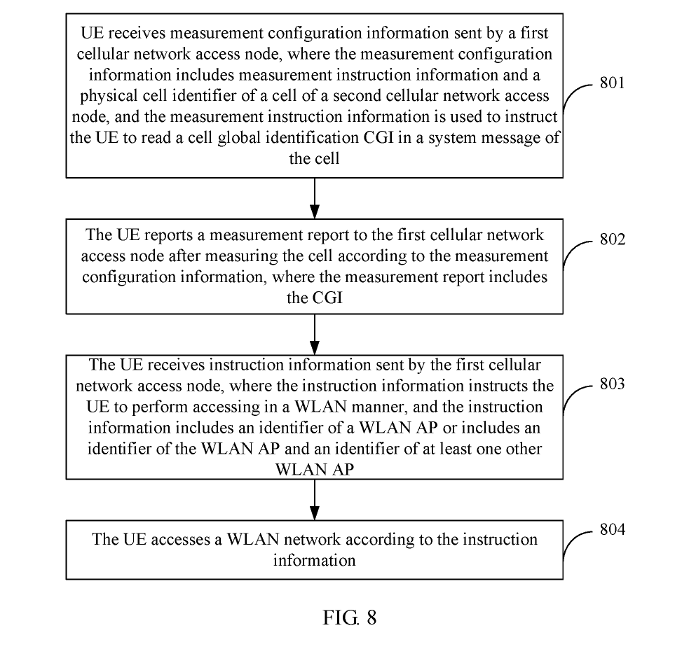

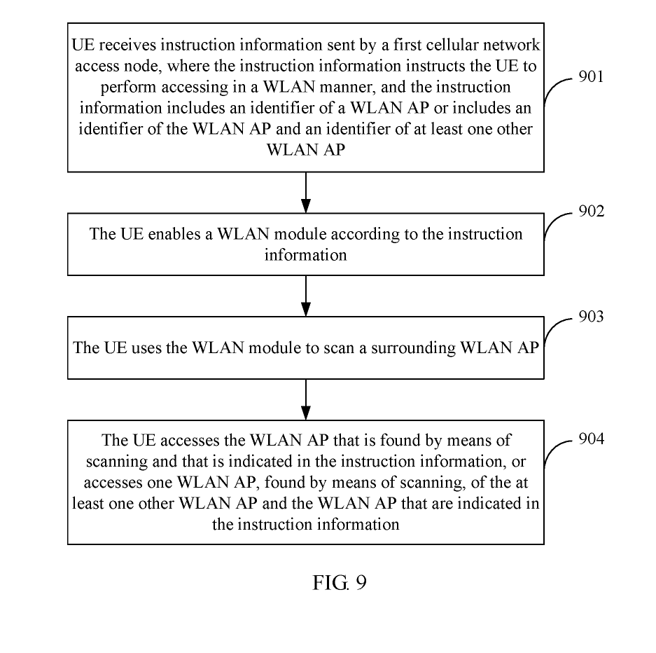

Referring to FIG. 9, this embodiment further provides a method for controlling access to a wireless local area network, and the method includes the following steps:

901. UE receives instruction information sent by a first cellular network access node, where the instruction information instructs the UE to perform accessing in a WLAN manner, and the instruction information includes an identifier of a WLAN AP or includes an identifier of the WLAN AP and an identifier of at least one other WLAN AP, where a service provided by the at least one other WLAN AP is the same as a service provided by the WLAN AP, and the WLAN AP meets an access condition of the UE.

902. The UE enables a WLAN module according to the instruction information.

903. The UE uses the WLAN module to scan a surrounding WLAN AP.

904. The UE accesses the WLAN AP that is found by means of scanning and that is indicated in the instruction information, or accesses one WLAN AP, found by means of scanning, of the at least one other WLAN AP and the WLAN AP that are indicated in the instruction information.

Preferably, the accessing one WLAN AP, found by means of scanning, of the at least one other WLAN AP and the WLAN AP that are indicated in the instruction information may include:
accessing one WLAN AP, having best signal quality and found by means of scanning, of the at least one other WLAN AP and the WLAN AP that are indicated in the instruction information.

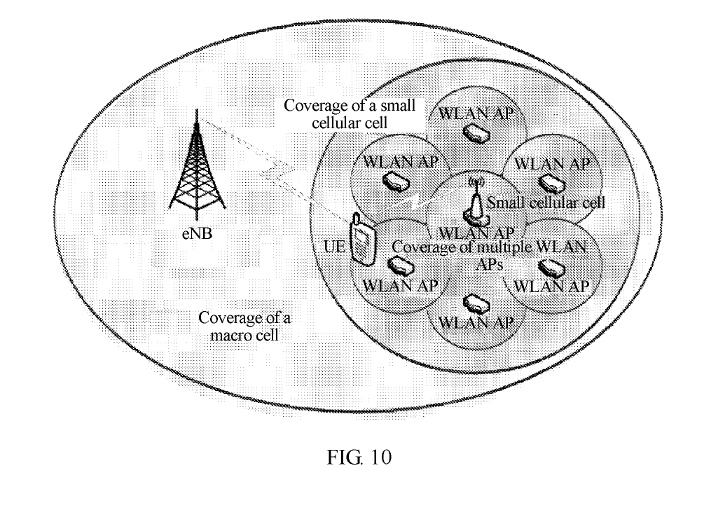

For example, referring to FIG. 10, UE currently camps in coverage of a macro eNB, and also camps in coverage of a small cellular cell, and there are seven WLAN APs nearby. According to an instruction to the UE from the eNB, the UE may select a WLAN AP that has best received signal quality, to perform accessing.

The best signal quality includes but is not limited to: strongest received signal strength, largest received signal power, or the like. This embodiment sets no specific limitation thereto.

In any one of the foregoing methods provided in this embodiment, the instruction information further includes an access manner in which the UE accesses the WLAN AP.

Further, the access manner includes at least one of the following access manners:
an Internet Protocol IP address preservation access manner, an IP address non-preservation access manner, a trusted access manner, an untrusted access manner, an interworking wireless local area network I-WLAN manner, a host-based Mobile Internet Protocol S2c manner, a non-seamless wireless local area network offload NSWO manner, a handover access manner, and a concurrent connection access manner.

In any one of the foregoing methods provided in this embodiment, before the receiving, by the UE, instruction information sent by the first cellular network access node, the method may further include:
sending, by the UE, a request message to the first cellular network access node, where the request message is used to request the first cellular network access node to determine whether there is a WLAN AP meeting the access condition of the UE.

Further, before the sending, by the UE, a request message to the first cellular network access node, the method may further include:
receiving, by the UE, an instruction that is sent by the first cellular network access node and that instructs the UE to enable a function of sending the request message.

In a scenario, the request message includes an identifier of the second cellular network access node; the request message is used to request the first cellular network access node to determine, according to a measurement report of the cell of the second cellular network access node, whether there is a WLAN AP meeting the access condition of the UE.

Further, before the sending, by the UE, a request message to the first cellular network access node, the method further includes:
detecting, by the UE, that quality of a signal received from the second cellular network access node is greater than a first specified threshold.

In another scenario, the request message includes an identifier of the second cellular network access node and the identifier of the WLAN AP; the request message is used to request the first cellular network access node to determine, according to a measurement report of the cell of the second cellular network access node, whether the WLAN AP corresponding to the identifier of the WLAN AP meets the access condition of the UE.

Further, the method further includes:
detecting, by the UE, that quality of a signal received from the second cellular network access node is greater than a first specified threshold; and
finding, by the UE by means of querying, a correspondence between the second cellular network access node and the WLAN AP from a historical access record.

In either of the foregoing scenarios, before the sending, by the UE, a request message to the first cellular network access node, the method further includes:
receiving, by the UE, an instruction that is sent by the first cellular network access node and that instructs to enable a function of sending the request message under a specified condition, where
the specified condition is that quality of a signal received by the UE from the second cellular network access node is greater than the first specified threshold.

Further, the method further includes:
detecting, by the UE, that the quality of the signal received from the second cellular network access node is less than a second specified threshold;
sending, by the UE, a leave notification message to the first cellular network access node; and
receiving, by the UE, an instruction message that is sent by the first cellular network access node and that is used to instruct the UE to disable a WLAN module.

In any one of the foregoing methods provided in this embodiment, the method may further include:
if the UE accesses the WLAN AP successfully, sending a notification indicating an access success; or
if the UE finds a WLAN AP by means of scanning and determines that the WLAN AP is available, sending a notification indicating that the WLAN AP is found; or
if the UE cannot perform accessing or fails to perform accessing after specified duration or a specified quantity of times, sending a notification indicating an access failure; or
if the UE cannot find the WLAN AP by means of scanning or determines that the WLAN AP is unavailable, sending a notification indicating that the WLAN AP cannot be found or the WLAN AP is unavailable, where the notification includes the identifier of the WLAN AP.

Preferably, any one of the notification indicating an access success, the notification indicating that the WLAN AP is found, the notification indicating an access failure, or the notification indicating that the WLAN AP cannot be found and the WLAN AP is unavailable may be sent by using a radio resource control RRC connection message or a user plane message.

In this embodiment, the instruction information may include a list of WLAN AP identifiers, where the list includes the identifier of the WLAN AP and the identifier of the at least one other WLAN AP, and an SSID corresponding to the at least one other WLAN AP is the same as an SSID corresponding to the WLAN AP. When finding, by means of scanning, multiple WLAN APs in the list, the UE may access a WLAN AP that is found by means of scanning and that has best signal quality, so as to improve service quality.

According to the foregoing methods provided in this embodiment, user equipment UE receives instruction information sent by a first cellular network access node, where the instruction information instructs the UE to perform accessing in a WLAN manner, and the instruction information includes an identifier of a WLAN AP or includes an identifier of the WLAN AP and an identifier of at least one other WLAN AP, where a service provided by the at least one other WLAN AP is the same as a service provided by the WLAN AP; and the UE accesses a WLAN network according to the instruction information. In this way, it is implemented that the WLAN AP can be quickly and effectively discovered by the UE, and a success rate of accessing a WLAN of a cellular network operator by the UE and utilization of the WLAN network are effectively improved, so that the WLAN network of the cellular network operator can effectively offload data flow pressure for a cellular network, thereby improving a throughput of an entire network. In addition, accessing is performed according to the received instruction, which avoids problems that electricity of the UE is consumed excessively fast, an available WLAN network cannot be effectively discovered, and congestion of an air interface of a WLAN network occurs that are caused when the UE continually scans and queries a WLAN network for a long time in a manner of autonomous discovery, and the like; in addition, a behavior of the UE is directed by a first cellular network to which the UE currently attaches, and the UE only needs to perform network discovery according to an instruction, so that the behavior is controllable, high efficiency is achieved, and implementation of the UE is simple.

### Embodiment 5

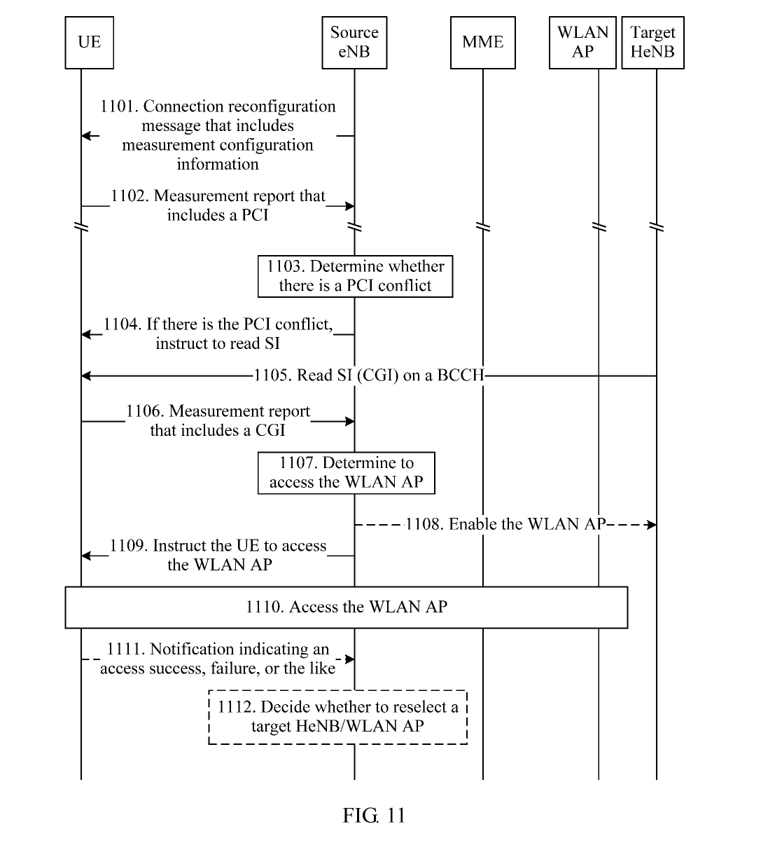

Referring to FIG. 11, this embodiment provides a method for controlling access to a wireless local area network, which is used in a scenario in which a first cellular network access node controls UE to access a WLAN AP. An example in which the first cellular network access node is an eNB and a second cellular network access node is an HeNB is used for description. A procedure in which a cellular network access node is another device is similar to this, and no excessive description is provided herein. The method includes the following steps:

1101. A source eNB sends an RRC connection reconfiguration message to the UE, where the RRC connection reconfiguration message carries measurement configuration information that instructs the UE to perform measurement, the measurement configuration information includes a PCI of a target HeNB, and the target HeNB is integrated or co-located with a WLAN AP.

In this embodiment, an example in which a cell identity of the target HeNB is the PCI of the target HeNB is used for description. In LTE, a physical cell identifier is a PCI; in 3G, a physical cell identifier is a primary scrambling code (PSC). No excessive description is provided herein.

The source eNB is a first cellular network access node that currently provides a service for the UE, and the target HeNB refers to a second cellular network access node that is integrated or co-located with a WLAN AP. The measurement configuration information may include a cell identity of one second cellular network access node, or may include cell identities of multiple second cellular network access nodes.

In this embodiment, the source eNB has learned information about the target HeNB and information about the WLAN AP that is integrated or co-located with the target HeNB, which include but are not limited to: an identifier, coverage, and transmit power that are of the target HeNB, and an identifier, a frequency, transmit power, a running state, a capability, load, a supported network access manner, a list of supported PLMNs, and the like that are of the WLAN AP. The source eNB may determine, according to coverage, in which a current position of the UE is possibly located, of target HeNBs with which WLAN APs are integrated or co-located, to send cell identities of these target HeNBs to the UE to instruct the UE to measure these target HeNBs.

1102. After receiving the RRC connection reconfiguration message, the UE acquires the measurement configuration information in the RRC connection reconfiguration message, measures the corresponding target HeNB according to a cell identity that is of the target HeNB and that is included in the measurement configuration information, and reports a measurement report to the source eNB, where the measurement report includes a PCI of each measured target HeNB.

In this embodiment, an example in which a physical cell identifier is a PCI is used for description, and in another application scenario, the physical cell identifier may also be a PSC.

Preferably, the UE may also report the measurement report when quality of a received signal reaches a preset threshold. The preset threshold may be set according to a requirement, and is not limited herein.

1103. The source eNB receives the measurement report that is reported by the UE, determines, according to the PCI in the measurement report, whether a PCI conflict occurs, and if the PCI conflict occurs, performs step 1104, or if the PCI conflict does not occur, performs step 1107.

In this embodiment, that the PCI conflict occurs means that different cellular network access nodes cannot be distinguished from each other because the cellular network access nodes use a same PCI.

For example, if a PCI of the second cellular network access node and a PCI of a cell of a macro cellular network access node are within a same value range and are the same, the first cellular network access node cannot distinguish, according to the PCI in the measurement report, whether the PCI is corresponding to the second cellular network access node or the macro cellular network access node. For another example, a special PCI value range is separately assigned to the second cellular network access node, because there is a relatively large quantity of second cellular network access nodes, different second cellular network access nodes may repeatedly use the PCI, and the first cellular network access node still cannot determine, according to the PCI in the measurement report, a second cellular network access node measured by the UE.

1104. The source eNB sends an RRC connection reconfiguration message to the UE to instruct the UE to read system information (SI) of a cell corresponding to the PCI.

1105. The UE reads the system message of the cell corresponding to the PCI, and acquires a CGI in the system message.

The system message includes at least the CGI, and in addition, the system message may further include one or more type of the following information, for example, a TAI (Tracking Area Identity, tracking area identity), a CSG (Closed Subscriber Group, closed subscriber group) identity, a member indicator, and an indicator of an integrated/co-located WLAN AP. The system message is generally transmitted through a BCCH (Broadcast Control Channel, broadcast control channel).

1106. The UE performs measurement according to the CGI, and reports a measurement report to the source eNB, where the measurement report includes a CGI of the measured target HeNB.

Preferably, the UE may further add, to the measurement report, information read from the system message, for example, one or more of the TAI, the CSG identity, the member indicator, and the indicator of the integrated/co-located WLAN AP.

1107. The source eNB finds a corresponding HeNB according to the PCI or the CGI in the measurement report, and determines, according to information about the target HeNB and information about the WLAN AP integrated or co-located with the target HeNB that are already learnt, that the HeNB is a cellular network access node with which a WLAN AP is integrated or co-located; then according to quality, in the measurement report, of a signal received by the UE, and a ratio of coverage of the target HeNB to coverage of the integrated or co-located WLAN AP and/or a ratio of transmit power of the target HeNB to transmit power of the integrated or co-located WLAN AP that are/is already learnt, the source eNB obtains, by means of calculation, a relative position of the UE in the coverage of the WLAN AP, or obtains, by means of calculation, quality of a signal received by the UE in a current position from the WLAN AP; and determines, according to the relative position of the UE in the coverage of the WLAN AP or the quality of the signal received by the UE in the current position from the WLAN AP that is obtained by means of calculation, whether the current position of the UE is suitable for accessing the WLAN AP.

If the PCI conflict occurs, the source eNB finds the corresponding HeNB according to the CGI in the received measurement report; if the PCI conflict does not occur, the source eNB finds the corresponding HeNB according to the PCI in the received measurement report.

If the measurement report received by the source eNB includes the indicator of the integrated/co-located WLAN AP, the source eNB may directly determine, according to the indication, that an eNB corresponding to the CGI in the measurement report is an eNB of the integrated or co-located WLAN AP.

Further, the source eNB may further determine, according to the information about the WLAN AP and a capability of the UE, that an access manner in which the UE accesses the WLAN AP is handover access or concurrent connection access, and indicate the determined access manner to the UE.

The information about the WLAN AP includes the identifier of the WLAN AP, or the information about the WLAN AP includes the identifier of the WLAN AP and at least one of the following:
a frequency of the WLAN AP;
load of the WLAN AP;
a network access manner supported by the WLAN AP; and
a list of PLMNs supported by the WLAN AP.

The list of PLMNs includes an identifier of each PLMN supported by the WLAN AP.

1108. If the source eNB determines that the current position of the UE is suitable for accessing the WLAN AP but the WLAN AP is not enabled yet, the source eNB sends an enable instruction to the target HeNB to instruct to enable the WLAN AP, so that the WLAN AP enters a running state.

Preferably, the source eNB may further add a specified frequency and/or specified transmit power to the enable instruction to instruct the target HeNB to adjust the frequency of the WLAN AP to the specified frequency and/or adjust the transmit power of the WLAN AP to the specified transmit power.

For example, if the source eNB obtains, by means of calculation, that the relative position of the UE in the coverage of the WLAN AP is relatively far away and is close to an edge of the coverage, or obtains, by means of calculation, that the quality of the signal received by the UE in the current position from the WLAN AP is relatively weak, the source eNB may instruct, in the foregoing manners, the WLAN AP to adjust the transmit power, so as to increase the transmit power of the WLAN AP and ensure that the UE is in a valid coverage of the WLAN AP.

This step is an optional step. If the WLAN AP is already enabled, there is no need to perform this step, and subsequent steps are directly performed.

1109. The source eNB sends a connection instruction that includes an identifier of the WLAN AP to the UE to instruct the UE to access the WLAN AP; or if the UE does not enable a WLAN module, the source eNB sends a connection instruction that includes an identifier of the WLAN AP to the UE to instruct the UE to enable the WLAN module and access the WLAN AP.

In this embodiment, the connection instruction may further carry at least one of the following:
a frequency of the WLAN AP;
load of the WLAN AP;
a network access manner supported by the WLAN AP or a network access manner indicated to the UE; and
a list of PLMNs supported by the WLAN AP or a list of PLMNs that is indicated to the UE.

The load of the WLAN AP refers to a comprehensive load capability of the WLAN AP, and may be represented by a percentage of resources already used by the WLAN AP in total resources or a percentage of resources that are not used by the WLAN AP in total resources. The resources include but are not limited to an air interface resource, backhaul bandwidth, a processing resource, a connection capacity, and the like that are of the WLAN AP. The network access manner indicated to the UE means that the source eNB directly indicates the network access manner to the UE after determining the network access manner, and the UE may perform accessing in the indicated network access manner. The list of PLMNs that is indicated to the UE includes an identifier of each PLMN indicated to the UE, and the UE may perform accessing according to the indicated PLMN list.

In this step, the connection instruction sent by the source eNB to the UE may be specifically sent to the UE by using a control plane RRC connection message or a user plane message. The control plane RRC connection message includes but is not limited to a Connection Reconfiguration message, a Connection Setup message, an RRC Connection Re-establishment message, and the like. The user plane message may be an application layer communication message or the like.

1110. After receiving the connection instruction that is sent by the source eNB and includes the identifier of the WLAN AP, the UE accesses, according to the connection instruction, the WLAN AP corresponding to the identifier.

The accessing, according to the connection instruction, the WLAN AP corresponding to the identifier may include:
enabling, by the UE, a WLAN module; and
scanning a surrounding WLAN AP, and accessing the WLAN AP when the WLAN AP corresponding to the identifier that is of the WLAN AP and that is included in the connection instruction is found by means of scanning.

The accessing the WLAN AP when the WLAN AP corresponding to the identifier that is of the WLAN AP and that is included in the connection instruction is found by means of scanning may include:
if the connection instruction carries a list that includes multiple WLAN AP identifiers, when WLAN APs corresponding to the multiple WLAN AP identifiers are found by means of scanning, selecting a WLAN AP that has best received signal quality from the WLAN APs that are found by means of scanning, to perform accessing.

In addition, if the connection instruction received by the UE carries information about a frequency, the UE may directly scan a surrounding WLAN AP on the frequency after enabling the WLAN module, and stops scanning when the WLAN AP corresponding to the identifier is found by means of scanning.

In this embodiment, if the source eNB indicates an access manner to the UE, the UE may access the WLAN AP in the access manner indicated by the source eNB; if the source eNB does not indicate an access manner to the UE, the UE may determine a proper access manner according to information about the WLAN AP and/or a capability of the UE that are/is carried in the connection instruction. The access manner includes handover access or concurrent connection access.

In this embodiment, the capability of the UE includes but is not limited to one or more of the following: whether a concurrent offloading service (for example, IFOM, MAPCON, and NSWO) is supported, a supported network access manner, a cellular radio access technology (LTE, UMTS, and GPRS) capability of the UE, and a WLAN capability (a supported 802.11 technical version and a frequency) of the UE.

The handover access means that the UE transfers all data flows to the WLAN AP to perform transmission, and the concurrent connection access means that the UE transfers some data flows to the WLAN AP to perform transmission. In a scenario of handover access, if the UE camps on LTE before a handover, when all data flows are transferred to a WLAN, the UE may perform cell reselection in a 2G or 3G network, and camp in a CS domain in the 2G or 3G network to ensure that a user normally uses a voice service. In a scenario of concurrent connection, if the UE has a PDN connection of an IP multimedia subsystem (IMS) service, the PDN connection of the IMS service may not be transferred to the WLAN.

1111. After accessing the WLAN AP, if the access is successful, the UE sends, to the source eNB, a notification indicating an access success; or if the UE finds the WLAN AP by means of scanning and determines that the WLAN AP is available, the UE sends a notification indicating that the WLAN AP is found to the source eNB; or if the UE cannot perform accessing or fails to perform accessing after specified duration or a specified quantity of times, the UE sends, to the source eNB, a notification indicating an access failure; or if the UE cannot find the WLAN AP by means of scanning or determines that the WLAN AP is unavailable, the UE sends a notification indicating that the WLAN AP cannot be found or the WLAN AP is unavailable to the source eNB, where the notification includes the identifier of the WLAN AP.

Any one of the notification indicating an access success, the notification indicating that the WLAN AP is found, the notification indicating an access failure, or the notification indicating that the WLAN AP cannot be found or the WLAN AP is unavailable may be sent by using an RRC connection message or a user plane message. The RRC connection message is, for example, a UL Information Transfer message; the user plane message is, for example, an application layer communication message.

In addition, the notification indicating an access success may further carry an access manner to the source eNB. The notification indicating an access failure may further carry a failure cause, for example, the UE does not support access to the WLAN AP, or does not support access to the WLAN AP in the manner indicated by the source eNB.

This step is an optional step. The UE may perform this step, or may not perform this step.

1112. The source eNB receives the notification sent by the UE, and if the received notification is the notification indicating an access failure or the notification indicating that the WLAN AP cannot be found or the WLAN AP is unavailable, or the notification is not received from the UE within specified duration, the source eNB may reselect, for the UE, a target HeNB to perform handover or a target WLAN AP to perform connection.

This step is an optional step. The eNB may perform this step, or may not perform this step.

According to the foregoing method provided in this embodiment, a source eNB sends measurement configuration information to UE, where the measurement configuration information includes a cell identity of a target HeNB; receives a measurement report that is reported by the UE after the UE performs measurement according to the measurement configuration information; and after determining, according to the measurement report and a coverage relationship between the target HeNB and a WLAN AP, that a current position of the UE is suitable for accessing the WLAN AP, instructs the UE to access the WLAN AP. In this way, it is implemented that the WLAN AP can be quickly and effectively discovered by the UE, and a success rate of accessing a WLAN of a cellular network operator by the UE and utilization of the WLAN network are effectively improved, so that the WLAN network of the cellular network operator can effectively offload data flow pressure for a cellular network, thereby improving a throughput of an entire network. In addition, the UE is accurately directed to discover, select, and access a WLAN, which not only makes a behavior of the UE become controllable, but also saves electricity of the UE and reduces power consumption of the UE.

### Embodiment 6

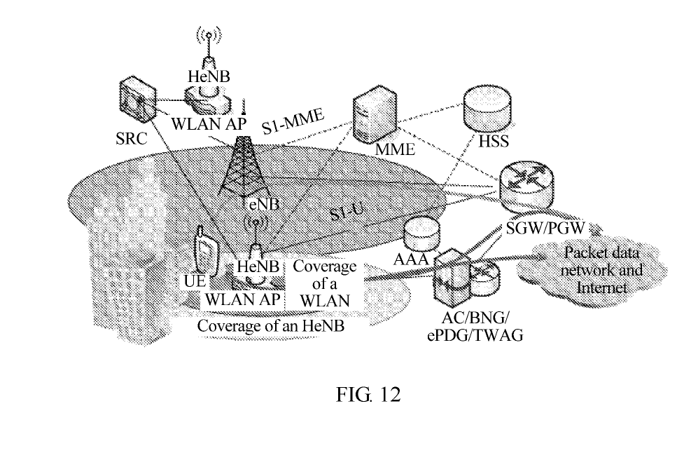

Referring to FIG. 12, FIG. 12 is a schematic diagram of another network architecture according to an embodiment of the present invention. A difference between the network architecture in this figure and the network architecture shown in FIG. 1 lies in that the network architecture in this figure further includes an SRC, where the SRC is connected to both a source eNB and a target HeNB through interfaces, and the connections are wired connections. The SRC may be an independent entity, or the SRC may be co-located or integrated with a cellular network access node.

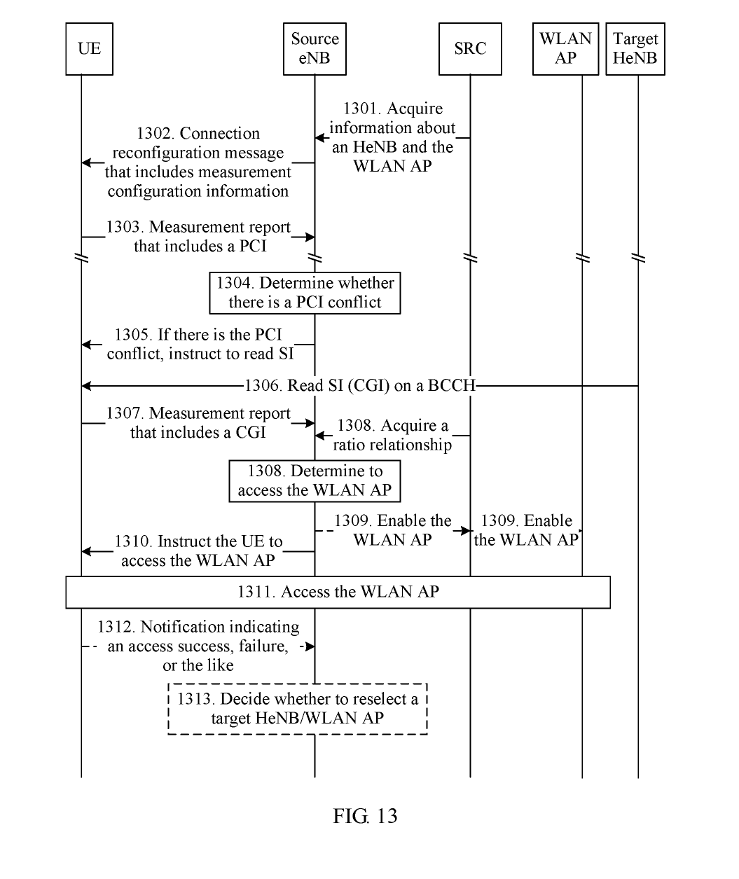

Referring to FIG. 13, this embodiment provides a method for controlling access to a wireless local area network, which is applicable to a scenario in which a first cellular network access node acquires information about a second cellular network access node and information about a WLAN AP from an SRC to make a decision. An example in which a first cellular network access node is an eNB and a second cellular network access node is an HeNB, as shown in FIG. 12, is used for description. A procedure in which a cellular network access node is another device is similar to this, and no excessive description is provided herein. The method includes the following steps:

1301. A source eNB acquires, from the SRC, information about a target HeNB and information about a WLAN AP that is integrated or co-located with the target HeNB.

In this embodiment, the SRC stores the information about the target HeNB and the information about the WLAN AP that is integrated or co-located with the target HeNB, which include but are not limited to: an identifier (for example, a PCI), coverage, and transmit power that are of the target HeNB, and an identifier, a frequency, transmit power, a running state, a capability, load, a supported network access manner, a list of supported PLMNs, and the like that are of the WLAN AP. The source eNB may determine, according to coverage, in which a current position of the UE is possibly located, of target HeNBs with which WLAN APs are integrated or co-located, to send cell identities of these target HeNBs to the UE to instruct the UE to measure these target HeNBs.

1302. The source eNB sends an RRC Reconfiguration connection reconfiguration message to UE, where the RRC connection reconfiguration message carries measurement configuration information to instruct the UE to perform measurement, and the measurement configuration information includes a PCI of the target HeNB.

In this embodiment, an example in which a physical cell identifier is a PCI is used for description, and in another application scenario, the physical cell identifier may also be a PSC.

1303. After receiving the RRC connection reconfiguration message, the UE acquires the measurement configuration information in the RRC connection reconfiguration message, measures a corresponding target HeNB according to a cell identity that is of the target HeNB and that is included in the measurement configuration information, and reports a measurement report to the source eNB, where the measurement report includes a PCI of each measured target HeNB.

Preferably, the UE may also report the measurement report when quality of a received signal reaches a preset threshold. The preset threshold may be set according to a requirement, and is not limited herein.

1304. The source eNB receives the measurement report that is reported by the UE, determines, according to the PCI in the measurement report, whether a PCI conflict occurs, and if the PCI conflict occurs, performs step 1305, or if the PCI conflict does not occur, performs step 1308.

In this embodiment, that the PCI conflict occurs means that different cellular network access nodes cannot be distinguished from each other because the cellular network access nodes use a same PCI. For details, refer to descriptions in the foregoing embodiment.

1305. The source eNB sends an RRC connection reconfiguration message to the UE to instruct the UE to read a system message SI of a cell corresponding to the PCI.

1306. The UE reads the system message of the cell corresponding to the PCI, and acquires a CGI in the system message.

1307. The UE performs measurement according to the CGI, and reports a measurement report to the source eNB, where the measurement report includes a CGI of the measured target HeNB.

1308. The source eNB finds a corresponding HeNB according to the PCI or the CGI in the measurement report, and determines, according to the information about the target HeNB and the information about the WLAN AP integrated or co-located with the target HeNB that are already acquired, that the HeNB is a cellular network access node with which a WLAN AP is integrated or co-located; then according to quality, in the measurement report, of a signal received by the UE, and a ratio of coverage of the target HeNB to coverage of the integrated or co-located WLAN AP and/or a ratio of transmit power of the target HeNB to transmit power of the integrated or co-located WLAN AP that are/is acquired from the SRC, the source eNB obtains, by means of calculation, a relative position of the UE in the coverage of the WLAN AP, or obtains, by means of calculation, quality of a signal received by the UE in a current position from the WLAN AP; and determines, according to the relative position of the UE in the coverage of the WLAN AP or the quality of the signal received by the UE in the current position from the WLAN AP that is obtained by means of calculation, whether the current position of the UE is suitable for accessing the WLAN AP.

If the PCI conflict occurs, the source eNB finds the corresponding HeNB according to the CGI in the received measurement report; if the PCI conflict does not occur, the source eNB finds the corresponding HeNB according to the PCI in the received measurement report.

In this embodiment, the SRC further stores the ratio of the coverage of the target HeNB to the coverage of the integrated or co-located WLAN AP and/or the ratio of the transmit power of the target HeNB to the transmit power of the integrated or co-located WLAN AP, and the source eNB may acquire the foregoing information from the SRC.

Further, the source eNB may further determine, according to the information about the WLAN AP and/or a capability of the UE, that an access manner in which the UE accesses the WLAN AP is handover access or concurrent connection access, and indicate the determined access manner to the UE.

1309. If the source eNB determines that the current position of the UE is suitable for accessing the WLAN AP but the WLAN AP is not enabled yet, the source eNB sends an enable instruction to the WLAN AP by using the SRC, to instruct the WLAN AP to enter a running state.

An example in which there is an interface between the SRC and the WLAN AP is used for description. Further, the source eNB may further add a specified frequency and/or specified transmit power to the enable instruction to instruct, by using the SRC, the WLAN AP to adjust the frequency to the specified frequency and/or adjust the transmit power to the specified transmit power.

Certainly, if there is no wired connection between the SRC and the WLAN AP, the source eNB may instruct the WLAN AP by using the target HeNB. For details, refer to descriptions in the foregoing embodiment, and the details are not described herein again.

This step is an optional step. If the WLAN AP is already enabled, there is no need to perform this step, and subsequent steps are directly performed.

1310. The source eNB sends a connection instruction that includes an identifier of the WLAN AP to the UE to instruct the UE to access the WLAN AP; or if the UE does not enable a WLAN module, the source eNB sends a connection instruction that includes an identifier of the WLAN AP to the UE to instruct the UE to enable the WLAN module and access the WLAN AP.

In this step, the connection instruction sent by the source eNB to the UE may be specifically sent to the UE by using a control plane RRC connection message or a user plane message.

1311. After receiving the connection instruction that is sent by the source eNB and includes the identifier of the WLAN AP, the UE accesses, according to the connection instruction, the WLAN AP corresponding to the identifier.

The accessing, according to the connection instruction, the WLAN AP corresponding to the identifier may include:
enabling, by the UE, a WLAN module; and
scanning a surrounding WLAN AP, and accessing the WLAN AP when the WLAN AP corresponding to the identifier that is of the WLAN AP and that is included in the connection instruction is found by means of scanning.

The accessing the WLAN AP when the WLAN AP corresponding to the identifier that is of the WLAN AP and that is included in the connection instruction is found by means of scanning may include:
if the connection instruction carries a list that includes multiple WLAN AP identifiers, when WLAN APs corresponding to the multiple WLAN AP identifiers are found by means of scanning, selecting a WLAN AP that has best received signal quality from the WLAN APs that are found by means of scanning, to perform accessing.

1312. After accessing the WLAN AP, if the access is successful, the UE sends, to the source eNB, a notification indicating an access success; or if the UE finds the WLAN AP by means of scanning and determines that the WLAN AP is available, the UE sends a notification indicating that the WLAN AP is found to the source eNB; or if the UE cannot perform accessing or fails to perform accessing after specified duration or a specified quantity of times, the UE sends, to the source eNB, a notification indicating an access failure; or if the UE cannot find the WLAN AP by means of scanning or determines that the WLAN AP is unavailable, the UE sends a notification indicating that the WLAN AP cannot be found or the WLAN AP is unavailable to the source eNB, where the notification includes the identifier of the WLAN AP.

Any one of the notification indicating an access success, the notification indicating that the WLAN AP is found, the notification indicating an access failure, or the notification indicating that the WLAN AP cannot be found or the WLAN AP is unavailable may be sent by using an RRC connection message or a user plane message.

This step is an optional step. The UE may perform this step, or may not perform this step.

1313. The source eNB receives the notification sent by the UE, and if the received notification is the notification indicating an access failure or the notification indicating that the WLAN AP cannot be found or the WLAN AP is unavailable, or the notification is not received from the UE within specified duration, the source eNB may reselect, for the UE, a target HeNB to perform handover or a target WLAN AP to perform connection.

This step is an optional step. The eNB may perform this step, or may not perform this step.

According to the foregoing method provided in this embodiment, a source eNB sends measurement configuration information to UE, where the measurement configuration information includes a cell identity of a target HeNB; receives a measurement report that is reported by the UE after the UE performs measurement according to the measurement configuration information; and after determining, according to the measurement report and a coverage relationship between the target HeNB and the WLAN AP, that a current position of the UE is suitable for accessing the WLAN AP, instructs the UE to access the WLAN AP. In this way, it is implemented that the WLAN AP can be quickly and effectively discovered by the UE, and a success rate of accessing a WLAN of a cellular network operator by the UE and utilization of the WLAN network are effectively improved, so that the WLAN network of the cellular network operator can effectively offload data flow pressure for a cellular network, thereby improving a throughput of an entire network. In addition, the UE is accurately directed to discover, select, and access a WLAN, which not only makes a behavior of the UE become controllable, but also saves electricity of the UE and reduces power consumption of the UE.

### Embodiment 7

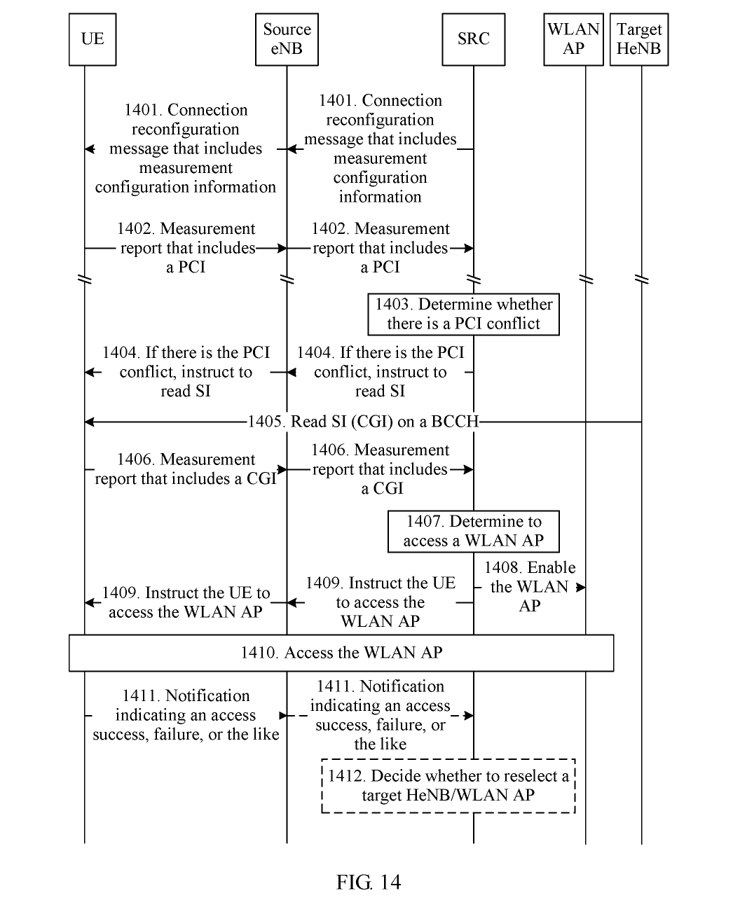

Referring to FIG. 14, this embodiment provides a method for controlling access to a wireless local area network, which is applicable to a scenario in which an SRC makes a decision according to information about a second cellular network access node and information about a WLAN AP. The scenario lies in a network architecture shown in FIG. 12, where the SRC is connected to both a source eNB and a target HeNB through interfaces, and the connections are wired connections. The SRC may be an independent entity, or the SRC may be co-located or integrated with a cellular network access node. Herein, an example in which a first cellular network access node is an eNB and the second cellular network access node is an HeNB is used for description. A procedure in which a cellular network access node is another device is similar to this, and no excessive description is provided herein. The method includes the following steps:

1401. The SRC generates measurement configuration information according to information about the target HeNB and information about a WLAN AP integrated or co-located with the target HeNB that are locally stored, and sends, to the source eNB, an RRC connection reconfiguration message that carries the measurement configuration information; the source eNB forwards the message to UE to instruct the UE to perform measurement, where the measurement configuration information includes a PCI of the target HeNB.

In this embodiment, an example in which a physical cell identifier is a PCI is used for description, and in another application scenario, the physical cell identifier may also be a PSC.

In this embodiment, step 1401 may be replaced by the following step:

The SRC instructs, according to the information about the target HeNB and the information about the WLAN AP that are locally stored, the source eNB to generate the measurement configuration information and send the measurement configuration information to the UE.

In this embodiment, the SRC stores the information about the target HeNB and the information about the WLAN AP that is integrated or co-located with the target HeNB, which include but are not limited to: an identifier (for example, a PCI), coverage, and transmit power that are of the target HeNB, and an identifier, a frequency, transmit power, a running state, a capability, load, a supported network access manner, a list of supported PLMNs, and the like that are of the WLAN AP. The SRC may determine, according to coverage, in which a current position of the UE is possibly located, of target HeNBs with which WLAN APs are integrated or co-located, to send cell identities of these target HeNBs to the UE to instruct the UE to measure these target HeNBs.

1402. After receiving the RRC connection reconfiguration message, the UE acquires the measurement configuration information in the RRC connection reconfiguration message, measures the corresponding target HeNB according to the PCI that is of the target HeNB and that is included in the measurement configuration information, and reports a measurement report to the source eNB; after receiving the measurement report that is reported by the UE, the source eNB forwards the measurement report to the SRC.

Preferably, the UE may also report the measurement report when quality of a received signal reaches a preset threshold.

1403. After receiving the measurement report that is reported by the UE and is forwarded by the source eNB, the SRC determines, according to the PCI in the measurement report, whether a PCI conflict occurs, and if the PCI conflict occurs, performs step 1404, or if the PCI conflict does not occur, performs step 1407.

In this embodiment, that the PCI conflict occurs means that different cellular network access nodes cannot be distinguished from each other because the cellular network access nodes use a same PCI. For details, refer to descriptions in the foregoing embodiment.

1404. The SRC sends an RRC connection reconfiguration message to the source eNB to instruct the UE to read an SI system message of a cell corresponding to the PCI, and the source eNB forwards the message to the UE.

1405. The UE reads the system message of the cell corresponding to the PCI, and acquires a CGI in the system message.

1406. The UE performs measurement according to the CGI, and reports a measurement report to the source eNB, where the measurement report includes a CGI of the measured target HeNB, and the source eNB forwards the measurement report to the SRC after receiving the measurement report.

1407. The SRC receives the measurement report that is reported by the UE and that is forwarded by the source eNB, finds a corresponding HeNB according to the PCI or the CGI in the measurement report, and determines, according to the information about the target HeNB and the information about the WLAN AP integrated or co-located with the target HeNB that are locally stored, that the HeNB is a cellular network access node with which a WLAN AP is integrated or co-located; then according to quality, in the measurement report, of a signal received by the UE, and a ratio of coverage of the target HeNB to coverage of the integrated or co-located WLAN AP and/or a ratio of transmit power of the target HeNB to transmit power of the integrated or co-located WLAN AP that are/is locally stored, the SRC obtains, by means of calculation, a relative position of the UE in the coverage of the WLAN AP, or obtains, by means of calculation, quality of a signal received by the UE in a current position from the WLAN AP; and determines, according to the relative position of the UE in the coverage of the WLAN AP or the quality of the signal received by the UE in the current position from the WLAN AP that is obtained by means of calculation, whether the current position of the UE is suitable for accessing the WLAN AP.

If the PCI conflict occurs, the SRC finds the corresponding HeNB according to the CGI in the received measurement report; if the PCI conflict does not occur, the SRC finds the corresponding HeNB according to the PCI in the received measurement report.

Further, the SRC may further determine, according to the information about the WLAN AP and/or a capability of the UE, that an access manner in which the UE accesses the WLAN AP is handover access or concurrent connection access, and indicate the determined access manner to the UE.

1408. If the SRC determines that the current position of the UE is suitable for accessing the WLAN AP but the WLAN AP is not enabled yet, the SRC directly sends an enable instruction to the WLAN AP to instruct the WLAN AP to enter a running state.

In this embodiment, there is an interface between the SRC and the WLAN AP, and there is a wired connection between the SRC and the WLAN AP.

Preferably, the SRC may further add a specified frequency and/or specified transmit power to the enable instruction to instruct the WLAN AP to adjust the frequency to the specified frequency and/or adjust the transmit power to the specified transmit power.

This step is an optional step. If the WLAN AP is already enabled, there is no need to perform this step, and subsequent steps are directly performed.

1409. The SRC sends a connection instruction that includes an identifier of the WLAN AP to the source eNB to instruct the UE to access the WLAN AP or instruct, in a case in which the UE does not enable a WLAN module, the UE to enable the WLAN module and access the WLAN AP; the source eNB forwards the connection instruction to the UE after receiving the connection instruction.

In this step, the connection instruction may be specifically sent to the UE by using a control plane RRC connection message or a user plane message.

1410. After receiving the connection instruction that includes the identifier of the WLAN AP, the UE accesses, according to the connection instruction, the WLAN AP corresponding to the identifier.

The accessing, according to the connection instruction, the WLAN AP corresponding to the identifier may include:
enabling, by the UE, the WLAN module; and
scanning a surrounding WLAN AP, and accessing the WLAN AP when the WLAN AP corresponding to the identifier that is of the WLAN AP and that is included in the connection instruction is found by means of scanning.

The accessing the WLAN AP when the WLAN AP corresponding to the identifier that is of the WLAN AP and that is included in the connection instruction is found by means of scanning may include:
if the connection instruction carries a list that includes multiple WLAN AP identifiers, when WLAN APs corresponding to the multiple WLAN AP identifiers are found by means of scanning, selecting a WLAN AP that has best received signal quality from the WLAN APs that are found by means of scanning, to perform accessing.

1411. After accessing the WLAN AP, if the access is successful, the UE sends, to the source eNB, a notification indicating an access success; or if the UE finds the WLAN AP by means of scanning and determines that the WLAN AP is available, the UE sends a notification indicating that the WLAN AP is found to the source eNB; or if the UE cannot perform accessing or fails to perform accessing after specified duration or a specified quantity of times, the UE sends, to the source eNB, a notification indicating an access failure; or if the UE cannot find the WLAN AP by means of scanning or determines that the WLAN AP is unavailable, the UE sends a notification indicating that the WLAN AP cannot be found or the WLAN AP is unavailable to the source eNB, where the notification includes the identifier of the WLAN AP; the source eNB forwards the notification to the SRC after receiving the notification.

The notification indicating an access success, the notification indicating that the WLAN AP is found, the notification indicating an access failure, or the notification indicating that the WLAN AP cannot be found or the WLAN AP is unavailable may be sent by using an RRC connection message or a user plane message.

1412. The SRC receives the notification forwarded by the source eNB, and if the received notification is the notification indicating an access failure or the notification indicating that the WLAN AP cannot be found or the WLAN AP is unavailable, or the notification is not received from the UE within specified duration, the SRC may reselect, for the UE, a target HeNB to perform handover or a target WLAN AP to perform connection.

The foregoing step 1411 and step 1412 are both optional steps.

According to the foregoing method provided in this embodiment, an SRC sends measurement configuration information to UE by using a source eNB, where the measurement configuration information includes a cell identity of a target HeNB; receives a measurement report that is forwarded by the source eNB and that is reported by the UE after the UE performs measurement according to the measurement configuration information; and after determining, according to the measurement report and a coverage relationship between the target HeNB and the WLAN AP, that a current position of the UE is suitable for accessing the WLAN AP, instructs, by using the source eNB, the UE to access the WLAN AP. In this way, it is implemented that the WLAN AP can be quickly and effectively discovered by the UE, and a success rate of accessing a WLAN of a cellular network operator by the UE and utilization of the WLAN network are effectively improved, so that the WLAN network of the cellular network operator can effectively offload data flow pressure for a cellular network, thereby improving a throughput of an entire network. In addition, the UE is accurately directed to discover, select, and access a WLAN, which not only makes a behavior of the UE become controllable, but also saves electricity of the UE and reduces power consumption of the UE.

### Embodiment 8

This embodiment is improved based on Embodiment 5, 6, or 7, where a step of performing reporting when UE approaches a second cellular network access node is added, so as to further increase a speed of discovering and accessing a WLAN AP by the UE. In the method for controlling access to a wireless local area network provided in Embodiment 5, 6, or 7, before the UE receives measurement configuration information, the method may further include the following steps:
locally recording, by the UE, related information of successfully accessing a WLAN AP previously, where the related information includes a correspondence between an identifier of a second cellular network access node and an identifier of a co-located or integrated WLAN AP, and a position in which the UE is located when the UE successfully accesses the WLAN AP; and
if an instruction that instructs to perform reporting when the UE approaches the second cellular network access node is received and the UE is located in the recorded position, sending a notification indicating that the UE approaches the second cellular network access node, where the notification is used to generate the measurement configuration information that includes the identifier of the second cellular network access node.

Specifically, the UE may store the related information of successfully accessing the WLAN AP previously in a context of the second cellular network access node. The identifier of the second cellular network access node includes but is not limited to a PCI/PSC, a CGI, and the like; the identifier of the WLAN AP includes but is not limited to an SSID, a BSSID, an HESSID, an OUI, and the like; the position in which the UE is located when the UE successfully accesses the WLAN AP may be GPS information, latitude and longitude information, or the like.

The notification indicating that the UE approaches the second cellular network access node may be carried in an RRC connection message sent by the UE, or may be carried in a user plane (for example, application layer communication) message.

In an implementation manner, the foregoing method may further include:
when the UE leaves the position, sending a notification indicating that the UE leaves the second cellular network access node.

The notification indicating that the UE leaves the second cellular network access node may be used to instruct the UE to disable a WLAN module.

The notification indicating that the UE leaves the second cellular network access node may be carried in an RRC connection message sent by the UE, or may be carried in a user plane (for example, application layer communication) message.

In another implementation manner, the foregoing method may further include:
receiving an instruction that instructs to enable a function of performing notifying when the UE approaches the second cellular network access node;
or
receiving an instruction that instructs to enable a function of performing notifying when the UE approaches the second cellular network access node, and an instruction that instructs to send, when quality of a signal received from the second cellular network access node is greater than a specified threshold, the notification indicating that the UE approaches the second cellular network access node.

After enabling, according to the received instruction, the function of performing notifying when the UE approaches the second cellular network access node, when receiving, in the recorded position, the signal from the second cellular network access node, the UE sends the notification indicating that the UE approaches the second cellular network access node; if the UE further receives the instruction that instructs to send, when the quality of the signal received from the second cellular network access node is greater than the specified threshold, the notification indicating that the UE approaches the second cellular network access node, after enabling the function of performing notifying when the UE approaches the second cellular network access node, when a signal is received in the recorded position from the second cellular network access node and quality of the received signal is greater than the specified threshold, the UE sends the notification indicating that the UE approaches the second cellular network access node. The specified threshold may be preset according to a requirement. This embodiment sets no specific limitation thereto.

In addition, in this embodiment, the UE may report, in an air interface capability of the UE that is sent to the first cellular network access node, a capability of supporting an approaching report, so that the first cellular network access node may determine, according to the capability, whether to send, to the UE, the instruction that instructs to enable the function of performing notifying when the UE approaches the second cellular network access node.

According to the foregoing method provided in this embodiment, a notification indicating that UE approaches a second cellular network access node is received, measurement configuration information is generated according to the notification and is sent to the UE, where the measurement configuration information includes a cell identity of a target HeNB; a measurement report that is reported by the UE after the UE performs measurement according to the measurement configuration information is received; and after it is determined, according to the measurement report and a coverage relationship between the target HeNB and the WLAN AP, that a current position of the UE is suitable for accessing the WLAN AP, the UE is instructed to access the WLAN AP. In this way, it is implemented that the WLAN AP can be quickly and effectively discovered by the UE, and a success rate of accessing a WLAN of a cellular network operator by the UE and utilization of the WLAN network are effectively improved, so that the WLAN network of the cellular network operator can effectively offload data flow pressure for a cellular network, thereby improving a throughput of an entire network. The measurement configuration information is generated according to information reported when the UE approaches the second cellular network access node, which further increases a speed of discovering and accessing the WLAN AP by the UE. In addition, the UE is accurately directed to discover, select, and access a WLAN, which not only makes a behavior of the UE become controllable, but also saves electricity of the UE and reduces power consumption of the UE.

### Embodiment 9

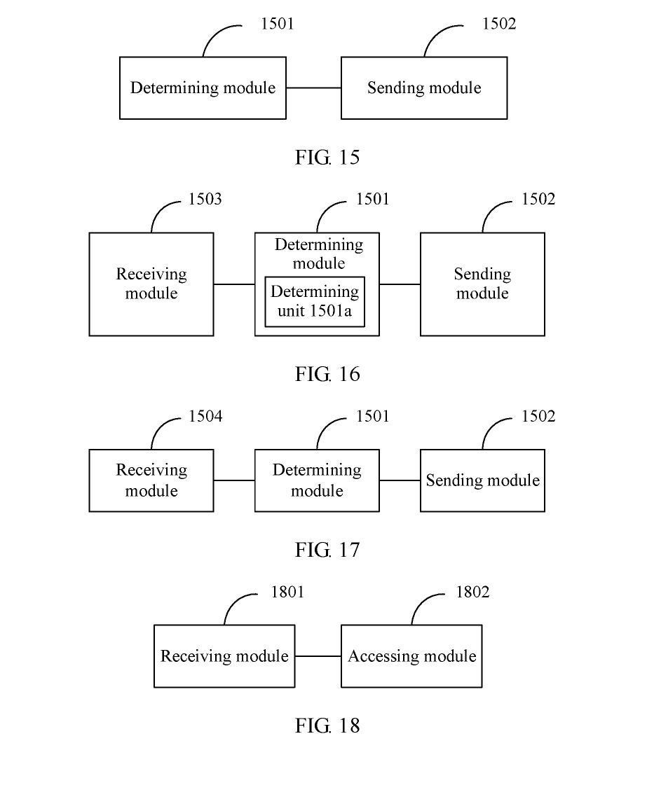

Referring to FIG. 15, this embodiment provides an apparatus for controlling access to a wireless local area network, including:
a determining module 1501, configured to determine that a wireless local area network access point WLAN AP meets an access condition of user equipment UE; and
a sending module 1502, configured to: after the determining module 1501 determines that the WLAN AP meets the access condition of the UE, send instruction information to the UE to instruct the UE to access a WLAN network, where the instruction information includes an identifier of the WLAN AP or includes an identifier of the WLAN AP and an identifier of at least one other WLAN AP, and a service provided by the at least one other WLAN AP is the same as a service provided by the WLAN AP.

Referring to FIG. 16, further, the apparatus further includes:
a receiving module 1503, configured to acquire a measurement report of a cell of a second cellular network access node from the UE, where
the determining module 1501 includes:
a determining unit 1501a, configured to determine, according to transmit power of the second cellular network access node, transmit power of the WLAN AP, and signal quality that is included in the measurement report, that the WLAN AP meets the access condition of the UE, where the signal quality is quality of a signal received by the UE from the second cellular network access node.

The measurement report includes at least an identifier of the second cellular network access node and quality information of the signal received by the UE from the second cellular network access node. The quality information of the signal includes but is not limited to: received signal strength (Received Signal Strength Indicator), received signal power (Reference Signal Receiving Power), or the like. This embodiment sets no specific limitation thereto.

The transmit power of the second cellular network access node and the transmit power of the WLAN AP may be stored on a first cellular network access node that includes the apparatus, so that it is more convenient to perform a search locally; or may be stored on an SRC (Single Radio Controller, single radio control), and a first cellular network access node may acquire the transmit power of the second cellular network access node and the transmit power of the WLAN AP from the SRC.

Further, the determining unit 1501a is configured to:
determine, according to the transmit power of the second cellular network access node, the transmit power of the WLAN AP, the signal quality that is included in the measurement report, a transmit frequency of the second cellular network access node, and a transmit frequency of the WLAN AP, that the WLAN AP meets the access condition of the UE, where the signal quality is the quality of the signal received by the UE from the second cellular network access node.

In this embodiment, the sending module 1502 is further configured to:
send measurement configuration information to the UE, where the measurement configuration information includes a physical cell identifier of the cell of the second cellular network access node.

Accordingly, the receiving module 1503 is configured to:
receive the measurement report that is reported by the UE after the UE measures the cell according to the measurement configuration information.

In this embodiment, the sending module 1502 is further configured to:
send measurement configuration information to the UE, where the measurement configuration information includes measurement instruction information and a physical cell identifier of the cell of the second cellular network access node, and the measurement instruction information is used to instruct the UE to read a cell global identification CGI in a system message of the cell.

Accordingly, the receiving module 1503 is configured to:
receive the measurement report that is reported by the UE after the UE measures the cell according to the measurement configuration information, where the measurement report includes the CGI.

The determining module 1501 is configured to:
determine, according to a fact that the CGI is a CGI of the second cellular network access node, that the measurement report is the measurement report of the cell of the second cellular network access node.

That the measurement instruction information instructs the UE to read the CGI in the system message of the cell is mainly considered from two aspects. First, after the UE measures the second cellular network access node, physical cell identifiers in the measurement report may be in conflict, physical cell identifiers of different cellular network access nodes may be duplicate, and a network needs to determine, according to the CGI, a target cellular network access node to which the measurement report reported by the UE corresponds. Second, not every site on which a cellular network access node is located is necessarily integrated or co-located with a WLAN AP, and the network needs to find a corresponding record of the cellular network access node according to the CGI and query whether the cellular network access node is integrated or co-located with a WLAN AP.

A reason why the physical cell identifiers are in conflict is that the physical cell identifier is a 9-bit identifier and has a limited selection range. When being used, especially for a cellular network access node with which a WLAN AP is integrated or co-located, in a specific area, for example, within cell coverage of a source base station, the physical cell identifier may be repeatedly used. Generally, the UE needs to report, in a measurement report, only a physical cell identifier and received signal quality, and in this way, it is difficult for the source base station to determine a cell to which the measurement report corresponds; therefore, a conflict between physical cell identifiers occurs.

In this embodiment, the instruction information further includes an access manner in which the UE accesses the WLAN AP, and the access manner is determined by the first cellular network access node according to information about the WLAN AP and/or a capability of the UE.

Preferably, the access manner includes at least one of the following access manners:
an Internet Protocol IP address preservation access manner, an IP address non-preservation access manner, a trusted access manner, an untrusted access manner, an interworking wireless local area network I-WLAN manner, a host-based Mobile Internet Protocol S2c manner, a non-seamless wireless local area network offload NSWO manner, a handover access manner, and a concurrent connection access manner.

In this embodiment, the information about the WLAN AP includes the identifier of the WLAN AP, or the information about the WLAN AP includes the identifier of the WLAN AP and at least one of the following:
a frequency of the WLAN AP;
load of the WLAN AP;
a network access manner supported by the WLAN AP; and
a list of public land mobile networks PLMNs supported by the WLAN AP.

The load of the WLAN AP refers to a comprehensive load capability of the WLAN AP, and may be represented by a percentage of resources already used by the WLAN AP in total resources or a percentage of resources that are not used by the WLAN AP in total resources. The resources include but are not limited to an air interface resource, backhaul bandwidth, a processing resource, a connection capacity, and the like that are of the WLAN AP.

The list of PLMNs includes an identifier of at least one PLMN, and a PLMN supported by the WLAN AP may be learned according to the identifier.

The capability of the UE includes but is not limited to one or more of the following: whether a concurrent offloading service (for example, IFOM, MAPCON, and NSWO) is supported, a supported network access manner, a cellular radio access technology (LTE, UMTS, and GPRS) capability of the UE, and a WLAN capability (a supported 802.11 technical version and a frequency) of the UE.

In this embodiment, the WLAN may further provide an NSWO (Non Seamless WLAN Offload, non-seamless WLAN offload) service or a concurrent offloading service to the UE. The NSWO means that the UE accesses a cellular network and receives/sends data through an air interface of the WLAN at the same time. The UE accesses a core network gateway in the cellular network, establishes a PDN (Packet Data Network, packet data network) connection, and uses an IP address assigned by the core network gateway to communicate with a peer end; in the WLAN, the UE directly accesses a service network through a fixed network, and uses an IP address assigned by the fixed network to communicate with a peer end.

The concurrent offloading service includes a seamless concurrent offloading IFOM (IP Flow Mobility, IP flow mobility) service or a non-seamless concurrent offloading MAPCON (Multi Access PDN Connectivity, multi access PDN connectivity) service. The IFOM means that the UE accesses a cellular network and receives/sends data through an air interface of the WLAN at the same time. The UE accesses a same core network gateway separately from the cellular network and the WLAN, and uses a same APN (Access Point Name, access point name) to establish two PDN connections. The UE uses, in the cellular and the WLAN, a same IP address assigned by a network (the same core network gateway) to communicate with a peer end. The MAPCON means that the UE accesses a cellular network and receives/sends data through an air interface of the WLAN at the same time. The UE accesses different core network gateways separately from the cellular network and the WLAN, and uses different APNs to establish two PDN connections. The UE uses, in the cellular and the WLAN, different IP addresses assigned by networks (the core network gateways) to communicate with a peer end.

In this embodiment, the sending module 1502 is further configured to:
before sending the instruction information to the UE to instruct the UE to access the WLAN network, when the WLAN AP is not enabled, send an enable instruction to the WLAN AP to instruct the WLAN AP to enter a running state.

In this embodiment, the sending module 1502 is further configured to:
indicate a specified frequency and/or transmit power to the WLAN AP.

In this embodiment, the instruction information further includes at least one of the following:
a frequency of the WLAN AP;
load of the WLAN AP;
a network access manner supported by the WLAN AP or a network access manner indicated to the UE; and
a list of PLMNs supported by the WLAN AP or a list of PLMNs that is indicated to the UE.

In this embodiment, the instruction information is sent to the UE by using a radio resource control RRC connection message or a user plane message.

In this embodiment, that a service provided by the at least one other WLAN AP is the same as a service provided by the WLAN AP includes:
a service set identifier SSID corresponding to the at least one other WLAN AP is the same as an SSID corresponding to the WLAN AP.

Referring to FIG. 17, in this embodiment, the apparatus further includes:
a receiving module 1504, configured to: before the determining module 1501 determines that the WLAN AP meets the access condition of the UE, receive a request message sent by the UE, where the request message is used to request the first cellular network access node to determine whether there is a WLAN AP meeting the access condition of the UE.

Further, the sending module 1502 is further configured to:
instruct the UE to enable a function of sending the request message.

In this embodiment, the receiving module 1504 is further configured to:
before acquiring the measurement report of the cell of the second cellular network access node from the UE, receive a request message sent by the UE, where the request message is used to request the first cellular network access node to determine, according to the measurement report of the cell of the second cellular network access node, whether there is a WLAN AP meeting the access condition of the UE.

Accordingly, the sending module is further configured to:
instruct the UE to enable a function of sending the request message under a specified condition, where the specified condition is that quality of a signal received by the UE from the second cellular network access node is greater than a specified threshold.

In this embodiment, the receiving module 1504 is further configured to:
receive a notification message that is sent by the UE and that is used to indicate that the UE leaves the second cellular network access node.

Accordingly, the sending module 1502 is further configured to:
instruct the UE to disable a WLAN module.

In this embodiment, the WLAN AP and the second cellular network access node are integrated or co-located.

In any implementation manner of this embodiment, the identifier of the WLAN AP includes but is not limited to any one of the following: an SSID (Service Set Identification, service set identifier), a BSSID (Basic Service Set Identification, basic service set identifier), an HESSID (Homogenous Extended Service Set Identifier, homogenous extended service set identifier), an OUI (Organization Universal Identity, organization universal identity), and an OI (Organization Identity, organization identity). The BSSID is a MAC (Media Access Control, Media Access Control) address of an AP, and is a universal unique identifier of the AP. The SSID is a service set identifier of a WLAN of an operator and identifies the WLAN network of the operator. The OUI/OI is a unique identifier of the WLAN roaming organization, and the UE may determine, by using the OUI/OI, whether the UE can access a home network of the UE by means of WLAN AP roaming, where the home network refers to a network that provides WLAN subscription.

The foregoing apparatus provided in this embodiment may be specifically located in the first cellular network access node, and the apparatus may perform the method provided in any one of the foregoing method embodiments. For a specific process, refer to the descriptions in the method embodiments, and details are not described herein again.

According to the foregoing apparatus provided in this embodiment, it is determined that a wireless local area network access point WLAN AP meets an access condition of user equipment UE, and instruction information is sent to the UE to instruct the UE to access a WLAN network, where the instruction information includes an identifier of the WLAN AP or includes an identifier of the WLAN AP and an identifier of at least one other WLAN AP, and a service provided by the at least one other WLAN AP is the same as a service provided by the WLAN AP, so that the UE can be directed to quickly and effectively discover, select, and access the WLAN. A network determines, according to cellular and WLAN network information learnt by the network and measurement performed by the UE under control, that the UE enters a WLAN network coverage area, which avoids problems that electricity of the UE is consumed excessively fast, an available WLAN network cannot be effectively discovered, and congestion of an air interface of a WLAN network occurs that are caused when the UE continually scans and queries a WLAN network for a long time in a manner of autonomous discovery, and the like; in addition, a behavior of the UE is directed by a cellular network to which the UE currently attaches, and the UE only needs to perform network discovery according to an instruction, so that the behavior is controllable, high efficiency is achieved, and implementation of the UE is simple.

### Embodiment 10

Referring to FIG. 18, this embodiment provides an apparatus for controlling access to a wireless local area network access point, including:
a receiving module 1801, configured to receive instruction information sent by a first cellular network access node, where the instruction information instructs to perform accessing in a WLAN manner, and the instruction information includes an identifier of a WLAN AP or includes an identifier of the WLAN AP and an identifier of at least one other WLAN AP, where a service provided by the at least one other WLAN AP is the same as a service provided by the WLAN AP, and the WLAN AP meets an access condition of UE; and
an accessing module 1802, configured to access a WLAN network according to the instruction information received by the receiving module.

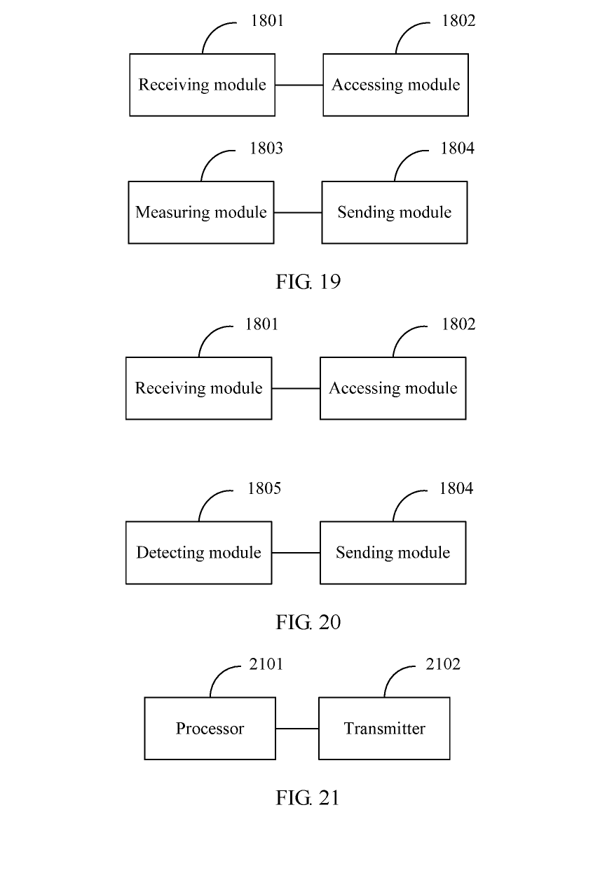

Referring to FIG. 19, in a scenario, the receiving module 1801 is further configured to:
receive measurement configuration information sent by the first cellular network access node, where the measurement configuration information includes a physical cell identifier of a cell of a second cellular network access node.

Accordingly, the apparatus further includes:
a measuring module 1803, configured to measure the cell according to the measurement configuration information; and
a sending module 1804, configured to report a measurement report to the first cellular network access node after the measuring module performs measurement.

In this embodiment, in another scenario, the receiving module is further configured to:
receive measurement configuration information sent by the first cellular network access node, where the measurement configuration information includes measurement instruction information and a physical cell identifier of a cell of a second cellular network access node, and the measurement instruction information is used to instruct the UE to read a cell global identification CGI in a system message of the cell.

Accordingly, the apparatus further includes:
a measuring module, configured to measure the cell according to the measurement configuration information; and
a sending module, configured to report a measurement report to the first cellular network access node after the measuring module performs measurement, where the measurement report includes the CGI.

In this embodiment, the accessing module includes:
an enabling unit, configured to enable a WLAN module;
a scanning unit, configured to use the WLAN module to scan a surrounding WLAN AP; and
an access unit, configured to: access the WLAN AP that is found by means of scanning and that is indicated in the instruction information, or access one WLAN AP, found by means of scanning, of the at least one other WLAN AP and the WLAN AP that are indicated in the instruction information.

Further, the access unit is configured to:
access one WLAN AP, having best signal quality and found by means of scanning, of the at least one other WLAN AP and the WLAN AP that are indicated in the instruction information.

The signal quality includes but is not limited to received signal strength or received signal power. The best signal quality refers to strongest received signal strength or largest received signal power, and worst signal quality refers to weakest received signal strength or smallest received signal power. This embodiment sets no specific limitation thereto.

In this embodiment, the instruction information further includes an access manner in which the UE accesses the WLAN AP.

Preferably, the access manner includes at least one of the following access manners:
an Internet Protocol IP address preservation access manner, an IP address non-preservation access manner, a trusted access manner, an untrusted access manner, an interworking wireless local area network I-WLAN manner, a host-based Mobile Internet Protocol S2c manner, a non-seamless wireless local area network offload NSWO manner, a handover access manner, and a concurrent connection access manner.

In this embodiment, in an implementation manner, either of the foregoing sending modules is further configured to:
before the receiving module receives the instruction information sent by the first cellular network access node, send a request message to the first cellular network access node, where the request message includes an identifier of the second cellular network access node, and the request message is used to request the first cellular network access node to determine, according to the measurement report of the cell of the second cellular network access node, whether there is a WLAN AP meeting the access condition of the UE.

Alternatively, in another implementation manner, either of the foregoing sending modules is further configured to:
before the receiving module receives the instruction information sent by the first cellular network access node, send a request message to the first cellular network access node, where the request message includes an identifier of the second cellular network access node and the identifier of the WLAN AP, and the request message is used to request the first cellular network access node to determine, according to the measurement report of the cell of the second cellular network access node, whether the WLAN AP corresponding to the identifier of the WLAN AP meets the access condition of the UE.

Referring to FIG. 20, further, in one of the foregoing implementation manners, the apparatus may further include:
a detecting module 1805, configured to: before the sending module sends the request message to the first cellular network access node, detect that quality of a signal received from the second cellular network access node is greater than a first specified threshold.

In the other of the foregoing implementation manners, further, the apparatus further includes:
a detecting module, configured to: before the sending module sends the request message to the first cellular network access node, detect that quality of a signal received from the second cellular network access node is greater than a first specified threshold; and
a querying module, configured to: after the detecting module detects that the quality of the signal received from the second cellular network access node is greater than the first specified threshold, find, by means of querying, a correspondence between the second cellular network access node and the WLAN AP from a historical access record.

Further, the receiving module is further configured to:
receive an instruction that is sent by the first cellular network access node and that instructs to enable a function of sending the request message under a specified condition, where
the specified condition is that quality of a signal received by the UE from the second cellular network access node is greater than the first specified threshold.

In this embodiment, the apparatus may further include:
a leave detecting module, configured to detect that the quality of the signal received from the second cellular network access node is less than a second specified threshold.

The sending module is further configured to:
send a leave notification message to the first cellular network access node.

The receiving module is further configured to:
receive an instruction message that is sent by the first cellular network access node and that is used to instruct the UE to disable a WLAN module.

In this embodiment, the WLAN AP and the second cellular network access node are integrated or co-located.

In this embodiment, the sending module is further configured to:
before the receiving module receives the instruction information sent by the first cellular network access node, send a request message to the first cellular network access node, where the request message is used to request the first cellular network access node to determine whether there is a WLAN AP meeting the access condition of the UE.

Further, the receiving module is further configured to:
receive an instruction that is sent by the first cellular network access node and that instructs the UE to enable a function of sending the request message.

In any implementation manner of this embodiment, the identifier of the WLAN AP includes but is not limited to any one of the following: an SSID (Service Set Identification, service set identifier), a BSSID (Basic Service Set Identification, basic service set identifier), an HESSID (Homogenous Extended Service Set Identifier, homogenous extended service set identifier), an OUI (Organization Universal Identity, organization universal identity), and an OI (Organization Identity, organization identity). The BSSID is a MAC (Media Access Control, Media Access Control) address of an AP, and is a universal unique identifier of the AP. The SSID is a service set identifier of a WLAN of an operator and identifies the WLAN network of the operator. The OUI/OI is a unique identifier of the WLAN roaming organization, and the UE may determine, by using the OUI/OI, whether the UE can access a home network of the UE by means of WLAN AP roaming, where the home network refers to a network that provides WLAN subscription.

In this embodiment, the instruction information may include a list of WLAN AP identifiers, where the list includes the identifier of the WLAN AP and the identifier of the at least one other WLAN AP, and an SSID corresponding to the at least one other WLAN AP is the same as an SSID corresponding to the WLAN AP. When finding, by means of scanning, multiple WLAN APs in the list, the UE may access a WLAN AP that is found by means of scanning and that has best signal quality, so as to improve service quality.

In this embodiment, that a service provided by the at least one other WLAN AP is the same as a service provided by the WLAN AP includes:
a service set identifier SSID corresponding to the at least one other WLAN AP is the same as an SSID corresponding to the WLAN AP.

The foregoing apparatus provided in this embodiment may be specifically located in the UE, and the apparatus may perform the method provided in any one of the foregoing method embodiments. For a specific process, refer to the descriptions in the method embodiments, and details are not described herein again.

According to the foregoing apparatus provided in this embodiment, instruction information sent by a first cellular network access node is received, where the instruction information instructs to perform accessing in a WLAN manner, and the instruction information includes an identifier of a WLAN AP or includes an identifier of the WLAN AP and an identifier of at least one other WLAN AP, where a service provided by the at least one other WLAN AP is the same as a service provided by the WLAN AP; and UE accesses a WLAN network according to the instruction information. In this way, it is implemented that the WLAN AP can be quickly and effectively discovered by the UE, and a success rate of accessing a WLAN of a cellular network operator by the UE and utilization of the WLAN network are effectively improved, so that the WLAN network of the cellular network operator can effectively offload data flow pressure for a cellular network, thereby improving a throughput of an entire network. In addition, accessing is performed according to the received instruction, which avoids problems that electricity of the UE is consumed excessively fast, an available WLAN network cannot be effectively discovered, and congestion of an air interface of a WLAN network occurs that are caused when the UE continually scans and queries a WLAN network for a long time in a manner of autonomous discovery, and the like; in addition, a behavior of the UE is directed by a first cellular network to which the UE currently attaches, and the UE only needs to perform network discovery according to an instruction, so that the behavior is controllable, high efficiency is achieved, and implementation of the UE is simple.

### Embodiment 11

Referring to FIG. 21, this embodiment provides an apparatus for controlling access to a wireless local area network, including:
a processor 2101, configured to determine that a wireless local area network access point WLAN AP meets an access condition of user equipment UE; and
a transmitter 2102, configured to: after the processor 2101 determines that the WLAN AP meets the access condition of the UE, send instruction information to the UE to instruct the UE to access a WLAN network, where the instruction information includes an identifier of the WLAN AP or includes an identifier of the WLAN AP and an identifier of at least one other WLAN AP, and a service provided by the at least one other WLAN AP is the same as a service provided by the WLAN AP.

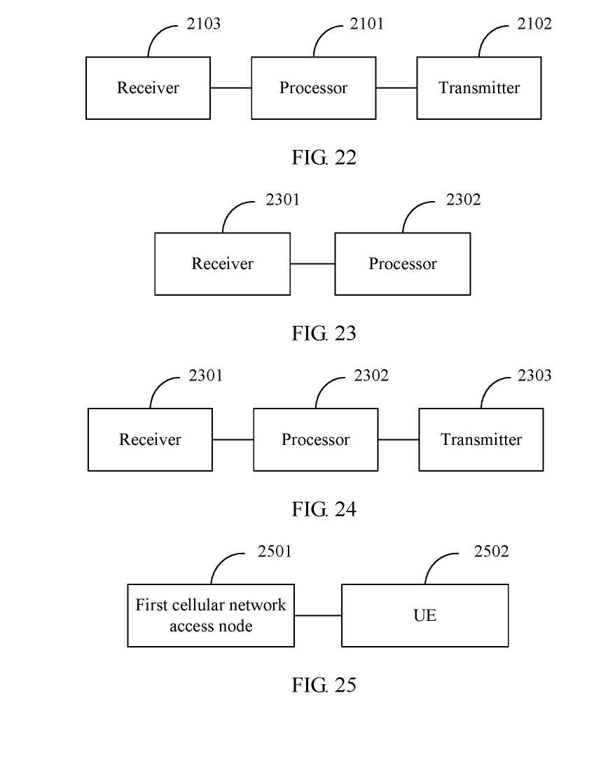

Referring to FIG. 22, further, the apparatus further includes:
a receiver 2103, configured to acquire a measurement report of a cell of a second cellular network access node from the UE.

Accordingly, the processor 2101 is configured to determine, according to transmit power of the second cellular network access node, transmit power of the WLAN AP, and signal quality that is included in the measurement report, that the WLAN AP meets the access condition of the UE, where the signal quality is quality of a signal received by the UE from the second cellular network access node.

The measurement report includes at least an identifier of the second cellular network access node and quality information of the signal received by the UE from the second cellular network access node. The quality information of the signal includes but is not limited to: received signal strength (Received Signal Strength Indicator), received signal power (Reference Signal Receiving Power), or the like. This embodiment sets no specific limitation thereto.

Further, the processor 2101 is configured to:
determine, according to the transmit power of the second cellular network access node, the transmit power of the WLAN AP, the signal quality that is included in the measurement report, a transmit frequency of the second cellular network access node, and a transmit frequency of the WLAN AP, that the WLAN AP meets the access condition of the UE, where the signal quality is the quality of the signal received by the UE from the second cellular network access node.

The transmit power of the second cellular network access node and the transmit power of the WLAN AP may be stored on the first cellular network access node, so that it is more convenient to perform a search locally; or may be stored on an SRC (Single Radio Controller, single radio control), and the first cellular network access node may acquire the transmit power of the second cellular network access node and the transmit power of the WLAN AP from the SRC.

In this embodiment, the transmitter 2102 is further configured to:
send measurement configuration information to the UE, where the measurement configuration information includes a physical cell identifier of the cell of the second cellular network access node.

Accordingly, the receiver 2103 is configured to:
receive the measurement report that is reported by the UE after the UE measures the cell according to the measurement configuration information.

In this embodiment, the transmitter 2102 is further configured to:
send measurement configuration information to the UE, where the measurement configuration information includes measurement instruction information and a physical cell identifier of the cell of the second cellular network access node, and the measurement instruction information is used to instruct the UE to read a cell global identification CGI in a system message of the cell.

Accordingly, the receiver 2103 is configured to:
receive the measurement report that is reported by the UE after the UE measures the cell according to the measurement configuration information, where the measurement report includes the CGI.

The processor 2101 is configured to:
determine, according to a fact that the CGI is a CGI of the second cellular network access node, that the measurement report is the measurement report of the cell of the second cellular network access node.

That the measurement instruction information instructs the UE to read the CGI in the system message of the cell is mainly considered from two aspects. First, after the UE measures the second cellular network access node, physical cell identifiers in the measurement report may be in conflict, physical cell identifiers of different cellular network access nodes may be duplicate, and a network needs to determine, according to the CGI, a target cellular network access node to which the measurement report reported by the UE corresponds. Second, not every site on which a cellular network access node is located is necessarily integrated or co-located with a WLAN AP, and the network needs to find a corresponding record of the cellular network access node according to the CGI and query whether the cellular network access node is integrated or co-located with a WLAN AP.

A reason why the physical cell identifiers are in conflict is that the physical cell identifier is a 9-bit identifier and has a limited selection range. When being used, especially for a cellular network access node with which a WLAN AP is integrated or co-located, in a specific area, for example, within cell coverage of a source base station, the physical cell identifier may be repeatedly used. Generally, the UE needs to report, in a measurement report, only a physical cell identifier and received signal quality, and in this way, it is difficult for the source base station to determine a cell to which the measurement report corresponds; therefore, a conflict between physical cell identifiers occurs.

In this embodiment, the instruction information further includes an access manner in which the UE accesses the WLAN AP, and the access manner is determined by the first cellular network access node according to information about the WLAN

AP and/or a capability of the UE.

Preferably, the access manner includes at least one of the following access manners:
an Internet Protocol IP address preservation access manner, an IP address non-preservation access manner, a trusted access manner, an untrusted access manner, an interworking wireless local area network I-WLAN manner, a host-based Mobile Internet Protocol S2c manner, a non-seamless wireless local area network offload NSWO manner, a handover access manner, and a concurrent connection access manner.

In this embodiment, the information about the WLAN AP includes the identifier of the WLAN AP, or the information about the WLAN AP includes the identifier of the WLAN AP and at least one of the following:
a frequency of the WLAN AP;
load of the WLAN AP;
a network access manner supported by the WLAN AP; and
a list of public land mobile networks PLMNs supported by the WLAN AP.

The load of the WLAN AP refers to a comprehensive load capability of the WLAN AP, and may be represented by a percentage of resources already used by the WLAN AP in total resources or a percentage of resources that are not used by the WLAN AP in total resources. The resources include but are not limited to an air interface resource, backhaul bandwidth, a processing resource, a connection capacity, and the like that are of the WLAN AP.

The list of PLMNs includes an identifier of at least one PLMN, and a PLMN supported by the WLAN AP may be learned according to the identifier.

The capability of the UE includes but is not limited to one or more of the following: whether a concurrent offloading service (for example, IFOM, MAPCON, and NSWO) is supported, a supported network access manner, a cellular radio access technology (LTE, UMTS, and GPRS) capability of the UE, and a WLAN capability (a supported 802.11 technical version and a frequency) of the UE.

In this embodiment, the WLAN may further provide an NSWO (Non Seamless WLAN Offload, non-seamless WLAN offload) service or a concurrent offloading service to the UE. The NSWO means that the UE accesses a cellular network and receives/sends data through an air interface of the WLAN at the same time. The UE accesses a core network gateway in the cellular network, establishes a PDN (Packet Data Network, packet data network) connection, and uses an IP address assigned by the core network gateway to communicate with a peer end; in the WLAN, the UE directly accesses a service network through a fixed network, and uses an IP address assigned by the fixed network to communicate with a peer end.

The concurrent offloading service includes a seamless concurrent offloading IFOM (IP Flow Mobility, IP flow mobility) service or a non-seamless concurrent offloading MAPCON (Multi Access PDN Connectivity, multi access PDN connectivity) service. The IFOM means that the UE accesses a cellular network and receives/sends data through an air interface of the WLAN at the same time. The UE accesses a same core network gateway separately from the cellular network and the WLAN, and uses a same APN (Access Point Name, access point name) to establish two PDN connections. The UE uses, in the cellular and the WLAN, a same IP address assigned by a network (the same core network gateway) to communicate with a peer end. The MAPCON means that the UE accesses a cellular network and receives/sends data through an air interface of the WLAN at the same time. The UE accesses different core network gateways separately from the cellular network and the WLAN, and uses different APNs to establish two PDN connections. The UE uses, in the cellular and the WLAN, different IP addresses assigned by networks (the core network gateways) to communicate with a peer end.

In this embodiment, the transmitter is further configured to:
before sending the instruction information to the UE to instruct the UE to access the WLAN network, when the WLAN AP is not enabled, send an enable instruction to the WLAN AP to instruct the WLAN AP to enter a running state.

In this embodiment, the transmitter is further configured to:
indicate a specified frequency and/or transmit power to the WLAN AP.

In this embodiment, the instruction information further includes at least one of the following:
a frequency of the WLAN AP;
load of the WLAN AP;
a network access manner supported by the WLAN AP or a network access manner indicated to the UE; and
a list of PLMNs supported by the WLAN AP or a list of PLMNs that is indicated to the UE.

In this embodiment, the instruction information is sent to the UE by using a radio resource control RRC connection message or a user plane message.

In this embodiment, that a service provided by the at least one other WLAN AP is the same as a service provided by the WLAN AP includes:
a service set identifier SSID corresponding to the at least one other WLAN AP is the same as an SSID corresponding to the WLAN AP.

In this embodiment, the apparatus further includes:
a receiver, configured to: before the processor determines that the WLAN AP meets the access condition of the UE, receive a request message sent by the UE, where the request message is used to request the first cellular network access node to determine whether there is a WLAN AP meeting the access condition of the UE.

Further, the transmitter 2102 is further configured to:
instruct the UE to enable a function of sending the request message.

In this embodiment, the receiver is further configured to:
before acquiring the measurement report of the cell of the second cellular network access node from the UE, receive a request message sent by the UE, where the request message is used to request the first cellular network access node to determine, according to the measurement report of the cell of the second cellular network access node, whether there is a WLAN AP meeting the access condition of the UE.

Accordingly, the transmitter 2102 is further configured to:
instruct the UE to enable a function of sending the request message under a specified condition, where the specified condition is that quality of a signal received by the UE from the second cellular network access node is greater than a specified threshold.

In this embodiment, the receiver is further configured to:
receive a notification message that is sent by the UE and that is used to indicate that the UE leaves the second cellular network access node.

Accordingly, the transmitter 2102 is further configured to:
instruct the UE to disable a WLAN module.

In this embodiment, the WLAN AP and the second cellular network access node are integrated or co-located.

The foregoing apparatus provided in this embodiment may be specifically located in the first cellular network access node, and the apparatus may perform the method provided in any one of the foregoing method embodiments. For a specific process, refer to the descriptions in the method embodiments, and details are not described herein again.

In any implementation manner of this embodiment, the identifier of the WLAN AP includes but is not limited to any one of the following: an SSID (Service Set Identification, service set identifier), a BSSID (Basic Service Set Identification, basic service set identifier), an HESSID (Homogenous Extended Service Set Identifier, homogenous extended service set identifier), an OUI (Organization Universal Identity, organization universal identity), and an OI (Organization Identity, organization identity). The BSSID is a MAC (Media Access Control, Media Access Control) address of an AP, and is a universal unique identifier of the AP. The SSID is a service set identifier of a WLAN of an operator and identifies the WLAN network of the operator. The OUI/OI is a unique identifier of the WLAN roaming organization, and the UE may determine, by using the OUI/OI, whether the UE can access a home network of the UE by means of WLAN AP roaming, where the home network refers to a network that provides WLAN subscription.

According to the foregoing apparatus provided in this embodiment, it is determined that a wireless local area network access point WLAN AP meets an access condition of user equipment UE, and instruction information is sent to the UE to instruct the UE to access a WLAN network, where the instruction information includes an identifier of the WLAN AP or includes an identifier of the WLAN AP and an identifier of at least one other WLAN AP, and a service provided by the at least one other WLAN AP is the same as a service provided by the WLAN AP, so that the UE can be directed to quickly and effectively discover, select, and access the WLAN. A network determines, according to cellular and WLAN network information learnt by the network and measurement performed by the UE under control, that the UE enters a WLAN network coverage area, which avoids problems that electricity of the UE is consumed excessively fast, an available WLAN network cannot be effectively discovered, and congestion of an air interface of a WLAN network occurs that are caused when the UE continually scans and queries a WLAN network for a long time in a manner of autonomous discovery, and the like; in addition, a behavior of the UE is directed by a cellular network to which the UE currently attaches, and the UE only needs to perform network discovery according to an instruction, so that the behavior is controllable, high efficiency is achieved, and implementation of the UE is simple.

### Embodiment 12

Referring to FIG. 23, this embodiment provides an apparatus for controlling access to a wireless local area network, including:
a receiver 2301, configured to receive instruction information sent by a first cellular network access node, where the instruction information instructs to perform accessing in a WLAN manner, and the instruction information includes an identifier of a WLAN AP or includes an identifier of the WLAN AP and an identifier of at least one other WLAN AP, where a service provided by the at least one other WLAN AP is the same as a service provided by the WLAN AP, and the WLAN AP meets an access condition of UE; and
a processor 2302, configured to access a WLAN network according to the instruction information received by the receiver 2301.

Referring to FIG. 24, in a scenario, the receiver 2301 is further configured to:
receive measurement configuration information sent by the first cellular network access node, where the measurement configuration information includes a physical cell identifier of a cell of a second cellular network access node.

Accordingly, the processor 2302 is further configured to measure the cell according to the measurement configuration information.

The apparatus further includes:
a transmitter 2303, configured to report a measurement report to the first cellular network access node after the processor performs measurement.

In this embodiment, in another scenario, the receiver is further configured to:
receive measurement configuration information sent by the first cellular network access node, where the measurement configuration information includes measurement instruction information and a physical cell identifier of a cell of a second cellular network access node, and the measurement instruction information is used to instruct the UE to read a cell global identification CGI in a system message of the cell.

Accordingly, the processor is further configured to measure the cell according to the measurement configuration information.

The apparatus further includes:
a transmitter, configured to report a measurement report to the first cellular network access node after the processor performs measurement, where the measurement report includes the CGI.

In this embodiment, the processor is configured to:
enable a WLAN module;
use the WLAN module to scan a surrounding WLAN AP; and
access the WLAN AP that is found by means of scanning and that is indicated in the instruction information, or access one WLAN AP, found by means of scanning, of the at least one other WLAN AP and the WLAN AP that are indicated in the instruction information.

Further, the processor is configured to:
access one WLAN AP, having best signal quality and found by means of scanning, of the at least one other WLAN AP and the WLAN AP that are indicated in the instruction information.

The signal quality includes but is not limited to received signal strength or received signal power. The best signal quality refers to strongest received signal strength or largest received signal power, and worst signal quality refers to weakest received signal strength or smallest received signal power.

In this embodiment, the instruction information further includes an access manner in which the UE accesses the WLAN AP.

Preferably, the access manner includes at least one of the following access manners:
an Internet Protocol IP address preservation access manner, an IP address non-preservation access manner, a trusted access manner, an untrusted access manner, an interworking wireless local area network I-WLAN manner, a host-based Mobile Internet Protocol S2c manner, a non-seamless wireless local area network offload NSWO manner, a handover access manner, and a concurrent connection access manner.

In this embodiment, in an implementation manner, either of the foregoing transmitters is further configured to:
before the receiver receives the instruction information sent by the first cellular network access node, send a request message to the first cellular network access node, where the request message includes an identifier of the second cellular network access node, and the request message is used to request the first cellular network access node to determine, according to the measurement report of the cell of the second cellular network access node, whether there is a WLAN AP meeting the access condition of the UE.

Alternatively, in another implementation manner, either of the foregoing transmitters is further configured to:
before the receiver receives the instruction information sent by the first cellular network access node, send a request message to the first cellular network access node, where the request message includes an identifier of the second cellular network access node and the identifier of the WLAN AP, and the request message is used to request the first cellular network access node to determine, according to the measurement report of the cell of the second cellular network access node, whether the WLAN AP corresponding to the identifier of the WLAN AP meets the access condition of the UE.

Further, in one of the foregoing implementation manners, the processor may be further configured to:
before the transmitter sends the request message to the first cellular network access node, detect that quality of a signal received from the second cellular network access node is greater than a first specified threshold.

In the other of the foregoing implementation manners, further, the processor may be further configured to:
before the transmitter sends the request message to the first cellular network access node, detect that quality of a signal received from the second cellular network access node is greater than a first specified threshold, and find, by means of querying, a correspondence between the second cellular network access node and the WLAN AP from a historical access record.

Further, the receiver is further configured to:
receive an instruction that is sent by the first cellular network access node and that instructs to enable a function of sending the request message under a specified condition, where
the specified condition is that quality of a signal received by the UE from the second cellular network access node is greater than the first specified threshold.

In this embodiment, the processor may be further configured to:
detect that the quality of the signal received from the second cellular network access node is less than a second specified threshold.

The transmitter is further configured to:
send a leave notification message to the first cellular network access node.

The receiver is further configured to:
receive an instruction message that is sent by the first cellular network access node and that is used to instruct the UE to disable a WLAN module.

In this embodiment, the WLAN AP and the second cellular network access node are integrated or co-located.

In this embodiment, the transmitter is further configured to:
before the receiver receives the instruction information sent by the first cellular network access node, send a request message to the first cellular network access node, where the request message is used to request the first cellular network access node to determine whether there is a WLAN AP meeting the access condition of the UE.

Further, the receiver is further configured to:
receive an instruction that is sent by the first cellular network access node and that instructs the UE to enable a function of sending the request message.

The foregoing apparatus provided in this embodiment may be specifically located in the UE, and the apparatus may perform the method provided in any one of the foregoing method embodiments. For a specific process, refer to the descriptions in the method embodiments, and details are not described herein again.

In any implementation manner of this embodiment, the identifier of the WLAN AP includes but is not limited to any one of the following: an SSID (Service Set Identification, service set identifier), a BSSID (Basic Service Set Identification, basic service set identifier), an HESSID (Homogenous Extended Service Set Identifier, homogenous extended service set identifier), an OUI (Organization Universal Identity, organization universal identity), and an OI (Organization Identity, organization identity). The BSSID is a MAC (Media Access Control, Media Access Control) address of an AP, and is a universal unique identifier of the AP. The SSID is a service set identifier of a WLAN of an operator and identifies the WLAN network of the operator. The OUI/OI is a unique identifier of the WLAN roaming organization, and the UE may determine, by using the OUI/OI, whether the UE can access a home network of the UE by means of WLAN AP roaming, where the home network refers to a network that provides WLAN subscription.

In this embodiment, the instruction information may include a list of WLAN AP identifiers, where the list includes the identifier of the WLAN AP and the identifier of the at least one other WLAN AP, and an SSID corresponding to the at least one other WLAN AP is the same as an SSID corresponding to the WLAN AP. When finding, by means of scanning, multiple WLAN APs in the list, the UE may access a WLAN AP that is found by means of scanning and that has best signal quality, so as to improve service quality.

In this embodiment, that a service provided by the at least one other WLAN AP is the same as a service provided by the WLAN AP includes:
a service set identifier SSID corresponding to the at least one other WLAN AP is the same as an SSID corresponding to the WLAN AP.

According to the foregoing apparatus provided in this embodiment, instruction information sent by a first cellular network access node is received, where the instruction information instructs to perform accessing in a WLAN manner, and the instruction information includes an identifier of a WLAN AP or includes an identifier of the WLAN AP and an identifier of at least one other WLAN AP, where a service provided by the at least one other WLAN AP is the same as a service provided by the WLAN AP; and UE accesses a WLAN network according to the instruction information. In this way, it is implemented that the WLAN AP can be quickly and effectively discovered by the UE, and a success rate of accessing a WLAN of a cellular network operator by the UE and utilization of the WLAN network are effectively improved, so that the WLAN network of the cellular network operator can effectively offload data flow pressure for a cellular network, thereby improving a throughput of an entire network. In addition, accessing is performed according to the received instruction, which avoids problems that electricity of the UE is consumed excessively fast, an available WLAN network cannot be effectively discovered, and congestion of an air interface of a WLAN network occurs that are caused when the UE continually scans and queries a WLAN network for a long time in a manner of autonomous discovery, and the like; in addition, a behavior of the UE is directed by a first cellular network to which the UE currently attaches, and the UE only needs to perform network discovery according to an instruction, so that the behavior is controllable, high efficiency is achieved, and implementation of the UE is simple.

### Embodiment 13

This embodiment provides a cellular network access node, including the apparatus for controlling access to a wireless local area network according to Embodiment 9 or 11.

For descriptions of a function of the apparatus in this embodiment, refer to the descriptions in Embodiment 9 or 11. Details are not described herein.

The cellular network access node in this embodiment may be an independent device, or may include multiple devices. For example, the cellular network access node may be an eNodeB in LTE, or the cellular network access node includes an RNC and a NodeB that are in 3G or the cellular network access node includes a BSC and a BTS that are in 2G.

The cellular network access node refers to a cellular network access node on which UE currently camps, and the cellular network access node currently provides a service for the UE.

The cellular network access node provided in this embodiment may perform the method provided in any one of the foregoing method embodiments. For a specific process, refer to the descriptions in the method embodiments, and details are not described herein again.

According to the cellular network access node provided in this embodiment, it is determined that a wireless local area network access point WLAN AP meets an access condition of user equipment UE, and instruction information is sent to the UE to instruct the UE to access a WLAN network, where the instruction information includes an identifier of the WLAN AP or includes an identifier of the WLAN AP and an identifier of at least one other WLAN AP, and a service provided by the at least one other WLAN AP is the same as a service provided by the WLAN AP, so that the UE can be directed to quickly and effectively discover, select, and access the WLAN. A network determines, according to cellular and WLAN network information learnt by the network and measurement performed by the UE under control, that the UE enters a WLAN network coverage area, which avoids problems that electricity of the UE is consumed excessively fast, an available WLAN network cannot be effectively discovered, and congestion of an air interface of a WLAN network occurs that are caused when the UE continually scans and queries a WLAN network for a long time in a manner of autonomous discovery, and the like; in addition, a behavior of the UE is directed by a cellular network to which the UE currently attaches, and the UE only needs to perform network discovery according to an instruction, so that the behavior is controllable, high efficiency is achieved, and implementation of the UE is simple.

### Embodiment 14

This embodiment provides user equipment UE, including the apparatus for controlling access to a wireless local area network according to Embodiment 10 or 12.

For descriptions of a function of the apparatus in this embodiment, refer to the descriptions in Embodiment 10 or 12. Details are not described herein again.

The UE provided in this embodiment may perform the method provided in any one of the foregoing method embodiments. For a specific process, refer to the descriptions in the method embodiments, and details are not described herein.

According to the foregoing UE provided in this embodiment, instruction information sent by a first cellular network access node is received, where the instruction information instructs the UE to perform accessing in a WLAN manner, and the instruction information includes an identifier of a WLAN AP or includes an identifier of the WLAN AP and an identifier of at least one other WLAN AP, where a service provided by the at least one other WLAN AP is the same as a service provided by the WLAN AP; and the UE accesses a WLAN network according to the instruction information. In this way, it is implemented that the WLAN AP can be quickly and effectively discovered by the UE, and a success rate of accessing a WLAN of a cellular network operator by the UE and utilization of the WLAN network are effectively improved, so that the WLAN network of the cellular network operator can effectively offload data flow pressure for a cellular network, thereby improving a throughput of an entire network. In addition, accessing is performed according to the received instruction, which avoids problems that electricity of the UE is consumed excessively fast, an available WLAN network cannot be effectively discovered, and congestion of an air interface of a WLAN network occurs that are caused when the UE continually scans and queries a WLAN network for a long time in a manner of autonomous discovery, and the like; in addition, a behavior of the UE is directed by a first cellular network to which the UE currently attaches, and the UE only needs to perform network discovery according to an instruction, so that the behavior is controllable, high efficiency is achieved, and implementation of the UE is simple.

### Embodiment 15

Referring to FIG. 25, this embodiment provides a system for controlling access to a wireless local area network, including a first cellular network access node 2501 and UE 2502.

A function of the first cellular network access node 2501 is the same as a function of the cellular network access node described in Embodiment 13; a function of the UE 2502 is the same as a function of the UE described in Embodiment 14. No excessive description is provided herein.

In this embodiment, further, the system may further include a second cellular network access node. Preferably, a WLAN AP is deployed on the second cellular network access node, and the deployment may be performed in an integrated or co-located (integrated or collocated) manner.

Either of the first cellular network access node and the second cellular network access node in this embodiment may be an independent device, or may include multiple devices. For example, the cellular network access node may be an eNodeB in LTE, or the cellular network access node includes an RNC and a NodeB that are in 3G or the cellular network access node includes a BSC and a BTS that are in 2G

The first cellular network access node involved in this embodiment refers to a cellular network access node on which UE currently camps, and the cellular network access node currently provides a service for the UE; the involved second cellular network access node may be a small cell, for example, a femto cell (femto cell), a pico cell (pico cell), a micro cell (micro cell), or an RRU (Radio Remote Unit, radio remote unit), in a cellular network such as 2G, 3G, LTE, CDMA 2000, or the like.

The foregoing system provided in this embodiment may perform the method provided in any one of the foregoing method embodiments. For a detailed process, refer to the descriptions in the method embodiments, and details are not described herein.

According to the foregoing system provided in this embodiment, a first cellular network access node determines that a wireless local area network access point WLAN AP meets an access condition of user equipment UE, and sends instruction information to the UE to instruct the UE to access a WLAN network, where the instruction information includes an identifier of the WLAN AP or includes an identifier of the WLAN AP and an identifier of at least one other WLAN AP, and a service provided by the at least one other WLAN AP is the same as a service provided by the WLAN AP; and the UE receives the instruction information and accesses the WLAN network according to the instruction information, so that the UE can be directed to quickly and effectively discover, select, and access the WLAN. A network determines, according to cellular and WLAN network information learnt by the network and measurement performed by the UE under control, that the UE enters a WLAN network coverage area, which avoids problems that electricity of the UE is consumed excessively fast, an available WLAN network cannot be effectively discovered, and congestion of an air interface of a WLAN network occurs that are caused when the UE continually scans and queries a WLAN network for a long time in a manner of autonomous discovery, and the like; in addition, a behavior of the UE is directed by a cellular network to which the UE currently attaches, and the UE only needs to perform network discovery according to an instruction, so that the behavior is controllable, high efficiency is achieved, and implementation of the UE is simple.

A person of ordinary skill in the art may understand that all or some of the steps of the embodiments may be implemented by hardware or a program instructing related hardware. The program may be stored in a computer-readable storage medium. The storage medium may include: a read-only memory, a magnetic disk, or an optical disc.

The foregoing descriptions are merely exemplary embodiments of the present invention, but are not intended to limit the present invention. Any modification, equivalent replacement, and improvement made without departing from the spirit and principle of the present invention shall fall within the protection scope of the present invention.

What is claimed is:

1. A method for controlling access to a wireless local area network, comprising:
receiving, by user equipment UE, instruction information sent by a first cellular network access node, wherein the instruction information instructs the UE to perform accessing in a WLAN manner, and the instruction information comprises an identifier of a WLAN AP or comprises an identifier of a WLAN AP and an identifier of at least one other WLAN AP, wherein a service provided by the at least one other WLAN AP is the same as a service provided by the WLAN AP, and the WLAN AP meets an access condition of the UE; and
accessing, by the UE, a WLAN network according to the instruction information.

2. The method according to claim 1, wherein the method further comprises:
receiving, by the UE, measurement configuration information sent by the first cellular network access node, wherein the measurement configuration information comprises a physical cell identifier of a cell of a second cellular network access node; and
reporting, by the UE, a measurement report to the first cellular network access node after measuring the cell according to the measurement configuration information.

3. The method according to claim 1, wherein the method further comprises:
receiving, by the UE, measurement configuration information sent by the first cellular network access node, wherein the measurement configuration information comprises measurement instruction information and a physical cell identifier of a cell of a second cellular network access node, and the measurement instruction information is used to instruct the UE to read a cell global identification CGI in a system message of the cell; and
reporting, by the UE, a measurement report to the first cellular network access node after measuring the cell according to the measurement configuration information, wherein the measurement report comprises the CGI.

4. An apparatus for controlling access to a wireless local area network, wherein the apparatus comprises:
a receiver, configured to receive instruction information sent by a first cellular network access node, wherein the instruction information instructs to perform accessing in a WLAN manner, and the instruction information comprises an identifier of a WLAN AP or comprises an identifier of the WLAN AP and an identifier of at least one other WLAN AP, wherein a service provided by the at least one other WLAN AP is the same as a service provided by the WLAN AP, and the WLAN AP meets an access condition of user equipment UE; and
a processor, configured to access a WLAN network according to the instruction information received by the receiving module.

5. The apparatus according to claim 4, wherein the receiver is further configured to:
receive measurement configuration information sent by the first cellular network access node, wherein the measurement configuration information comprises a physical cell identifier of a cell of a second cellular network access node; and
the processor, also configured to measure the cell according to the measurement configuration information;
the apparatus further comprises:
a sender, configured to report a measurement report to the first cellular network access node after the measuring module performs measurement.

6. The apparatus according to claim 4, wherein the receiver is further configured to:
receive measurement configuration information sent by the first cellular network access node, wherein the measurement configuration information comprises measurement instruction information and a physical cell identifier of a cell of a second cellular network access node, and the measurement instruction information is used to instruct to read a cell global identification CGI in a system message of the cell; and,
the processor, configured to measure the cell according to the measurement configuration information; and
the apparatus further comprises:
a sender, configured to report a measurement report to the first cellular network access node after the measuring module performs measurement, wherein the measurement report comprises the CGI.

7. The apparatus according to claim 5, wherein the sender is further configured to:
before the receiver receives the instruction information sent by the first cellular network access node, send a request message to the first cellular network access node, wherein the request message comprises an identifier of the second cellular network access node, and the request message is used to request the first cellular network access node to determine, according to the measurement report of the cell of the second cellular network access node, whether there is a WLAN AP meeting the access condition of the UE.

8. The apparatus according to claim 5, wherein the sender is further configured to:
before the receiver receives the instruction information sent by the first cellular network access node, send a request message to the first cellular network access node, wherein the request message comprises an identifier of the second cellular network access node and the identifier of the WLAN AP, and the request message is used to request the first cellular network access node to determine, according to the measurement report of the cell of the second cellular network access node, whether the WLAN AP corresponding to the identifier of the WLAN AP meets the access condition of the UE.

9. The apparatus according to claim 7, wherein the apparatus further comprises:
a detector, configured to: before the sending module sends the request message to the first cellular network access node, detect that quality of a signal received from the second cellular network access node is greater than a first specified threshold.

10. The apparatus according to claim 8, wherein the apparatus further comprises:
a detector, configured to: before the sender sends the request message to the first cellular network access node, detect that quality of a signal received from the second cellular network access node is greater than a first specified threshold; and
the processor, configured to: after the detector detects that the quality of the signal received from the second cellular network access node is greater than the first specified threshold, find, by means of querying, a correspondence between the second cellular network access node and the WLAN AP from a historical access record.

11. The apparatus according to claim 9, wherein the receiver is further configured to:
receive an instruction that is sent by the first cellular network access node and that instructs to enable a function of sending the request message under a specified condition, wherein
the specified condition is that quality of a signal received by the UE from the second cellular network access node is greater than the first specified threshold.

12. The apparatus according to claim 7, wherein the apparatus further comprises:
a leave detector, configured to detect that the quality of the signal received from the second cellular network access node is less than a second specified threshold, wherein
the sender is further configured to send a leave notification message to the first cellular network access node; and
the receiver is further configured to receive an instruction message that is sent by the first cellular network access node and that is used to instruct the UE to disable a WLAN module.

13. The apparatus according to claim 5, wherein the WLAN AP and the second cellular network access node are integrated or co-located.

14. The apparatus according to claim 5, wherein the sending module is further configured to:
before the receiver receives the instruction information sent by the first cellular network access node, send a request message to the first cellular network access node, wherein the request message is used to request the first cellular network access node to determine whether there is a WLAN AP meeting the access condition of the UE.

15. The apparatus according to claim 14, wherein the receiver is further configured to:
receive an instruction that is sent by the first cellular network access node and that instructs the UE to enable a function of sending the request message.

16. The apparatus according to claim 4, wherein the processor module comprises:
an enabling unit, configured to enable a WLAN module;
a scanning unit, configured to use the WLAN module to scan a surrounding WLAN AP; and
an access unit, configured to: access the WLAN AP that is found by means of scanning and that is indicated in the instruction information, or access one WLAN AP, found by means of scanning, of the at least one other WLAN AP and the WLAN AP that are indicated in the instruction information.

17. The apparatus according to claim 16, wherein the access unit is configured to:
access one WLAN AP, having best signal quality and found by means of scanning, of the at least one other WLAN AP and the WLAN AP that are indicated in the instruction information.

18. The apparatus according to claim 4, wherein the instruction information further comprises an access manner of accessing the WLAN AP.

19. The apparatus according to claim 18, wherein the access manner comprises at least one of the following access manners:
an Internet Protocol IP address preservation access manner, an IP address non-preservation access manner, a trusted access manner, an untrusted access manner, an interworking wireless local area network I-WLAN manner, a host-based Mobile Internet Protocol S2c manner, a non-seamless wireless local area network offload NSWO manner, a handover access manner, and a concurrent connection access manner.

20. The apparatus according to claim 4, wherein that a service provided by the at least one other WLAN AP is the same as a service provided by the WLAN AP comprises:
a service set identifier SSID corresponding to the at least one other WLAN AP is the same as an SSID corresponding to the WLAN AP.
